(19) United States
(12) Patent Application Publication
(10) Pub. No.: US 2008/0251575 A1
(43) Pub. Date: Oct. 16, 2008

(54) SYSTEM FOR CAPTURING AND MANAGING PERSONALIZED VIDEO IMAGES OVER AN IP-BASED CONTROL AND DATA LOCAL AREA NETWORK

(75) Inventors: GARY BOWLING, Bellaire, TX (US); Mike FEDAK, Surrey (GB); RICHARD BYRNE, London (GB); DAVID RUSSELL CARR, Hampshire (GB)

Correspondence Address: MCCORMICK, PAULDING & HUBER LLP, CITY PLACE II, 185 ASYLUM STREET, HARTFORD, CT, 06103, US

(73) Assignee: YOURDAY, INC., Haverhill, MA (US)

(21) Appl. No.: 12/060,905

(22) Filed: Apr. 2, 2008

Related U.S. Application Data
(60) Provisional application No. 60/911,660, filed on Apr. 13, 2007.

(51) Int. Cl. G06F 19/00

(52) U.S. Cl. 235/375

(57) ABSTRACT

A system is deployed at a theme park for capturing and managing personalized video images, e.g., for creating personalized video products for patrons at the theme park. The system includes an RFID system to track patron movements around the park, a camera system to capture video images at designated locations around the park, a computer-based video content collection system to collect and store personalized video clips of patrons, and a video product (e.g., DVD) creation and point of sale system to create the end product for sale to the patron.

### CROSS-REFERENCE TO RELATED APPLICATION

This application claims the benefit of Provisional Application Ser. No. 60/911,660, filed Apr. 13, 2007, the entirety of which is incorporated by reference herein in its entirety.

### FIELD OF THE INVENTION

The present invention relates to systems for processing video signals for dynamic recording or reproduction and, more specifically, to a system for automatically capturing personalized video images and integrating those images into an end-user video product containing both professionally shot video and the personalized video images.

### BACKGROUND OF THE INVENTION

Various systems have been proposed over the years for producing personalized video products for patrons at amusement parks or other attractions. In such systems, cameras are deployed at designated locations and/or near designated rides. Customers are provided with RFID tags or other identification means, and video is taken of the customers when they visit the designated locations or go on the designated rides. The video segments are associated with particular customers by way of the RFID tags. The video segments for each customer are recorded to a video tape for the customer to take home, typically in exchange for a fee. Personalized video segments may be interspersed with stock footage of the amusement park to provide a longer and more cohesive video program.

Although the previously proposed systems have identified the desirable set of characteristics for the video end product (e.g., personalized video in combination with stock footage), these systems have heretofore not been successfully commercially implemented. This is because it has proven difficult to capture and accurately manage large amounts of video data in a distributed environment, in a cost effective manner, and in light of “point of sale” constraints relating to timely generating a final consumer product (e.g., DVD or video tape) in a short time frame.

### SUMMARY OF THE INVENTION

An embodiment of the present invention relates to a system for capturing and managing personalized video images, e.g., for creating personalized DVD's or other video products for patrons at a theme park or other geographic area. The system includes an RFID system to track patron movements around the park, a camera system to capture video images at designated locations around the park, a computer-based video content collection system to collect and store personalized video clips of patrons, and a video product creation and point of sale system to create the end product for sale to the patron.

In another embodiment, the system includes an RFID system, a video content collection system, and a video product creation system. The system also includes a plurality of cameras and one or more digital video recorders interfaced with the cameras. The cameras are positioned at different locations around the theme park or other geographic area. The locations might be, for example, rides or other attractions at the theme park. Each camera is “always on,” meaning it outputs video content during the hours of operation of the ride or attraction at which it is located. The digital video recorders substantially continuously record the video output of the cameras. (By “substantially continuously,” it is meant either continuous, or continuous but for very small time gaps (<0.5 second) required for breaking the video content into manageable clips and/or for recycling “loop-type” digital video storage.) The RFID system includes a plurality of RFID readers positioned at the ride locations, which detect customer identifiers stored on RFID devices carried by customers, e.g., the customers are provided with the RFID devices when they elect to participate in the system. The video content collection system is interfaced with the RFID system and the digital video recorders. The video content collection system associates designated clip portions of the recorded camera video outputs (e.g., those portions of the recorded video content that contain personalized video content of the customers on rides or attractions) with the customer identifiers. The video product creation system is interfaced with the video content collection system, and produces personalized DVD's or other video products using the personalized video content from the video content collection system. The personalized video products include the personalized video content interspersed with stock video clips of the theme park.

In another embodiment, there is one digital video recorder for each camera, which is located locally to the camera. This provides for redundant and reliable local storage, thereby increasing system uptime. Additionally, continuous local recording provides an enhanced degree of flexibility for detecting RFID's and associating customers with personalized video clips, e.g., it is possible to look forward or back in time along the recorded video output to identify content of interest.

In another embodiment, each digital video recorder records the video output of a camera as a plurality of near contiguous raw video clips. By “near contiguous,” it is meant contiguous but for very small time gaps (<0.5 second) required for creating the clips from the video feed. The raw clips include both “non-content” video clips, meaning clips that lack video content of RFID-equipped customers, and “designated” video clips, meaning clips that contain video content of RFID-equipped customers. As should be appreciated, the video content collection system is configured to identify the designated video clips from among the plurality of raw video clips for associating with customer identifiers, based on time correlations or otherwise.

At a typical theme park ride or attraction, the ride occurs on a regular, periodic basis. Accordingly, the video content collection system associates a “ride cycle number” (also referred to as an event cycle number) with each instance of the event. The event cycle number uniquely identifies the event instance from among all other event instances occurring in the theme park. The video content collection system additionally associates one or more customer identifiers with the event cycle number, e.g., based on data from the RFID system. The designated video clips, which are located among the raw video clips of the recorded video output of the camera at the locale, are associated with customer identifiers based at least in part on the event cycle numbers of the periodically occurring event.

### BRIEF DESCRIPTION OF THE DRAWINGS

The present invention will be better understood from reading the following description of non-limiting embodiments, with reference to the attached drawings, wherein below:

FIG. 1 is a schematic diagram of a system for capturing and managing personalized video images, according to an embodiment of the present invention;

FIG. 2 is a schematic diagram of the system as implemented in a theme park;

FIGS. 3A-3F are various views of an RFID bracelet device;

FIGS. 4A and 4B are schematic diagrams of an RFID system;

FIGS. 5A-5E are various views of RFID antennas;

FIGS. 6A-6C are flowcharts explaining the operation of an in vehicle computer (IVC) RFID application;

FIGS. 7A-7D are various views of a camera housing;

FIGS. 8A-8D are various views of a pan and tilt camera head;

FIGS. 9A-9C are various views of a camera housing wiper unit;

FIGS. 10 and 11 are schematic views of a network node structure;

FIG. 12 is a schematic view of a IP local area network;

FIG. 13 is a flow chart showing how a patron interacts with the video capture system;

FIGS. 14, 15, 16A, and 16B are flow and schematic diagrams showing how the system operates for capturing and tracking personalized video content;

FIGS. 17A-17D are flow charts explaining the operation of various software/sub-system portions of the video capture system;

FIG. 18 shows an order list screen display;

FIG. 19 is a schematic diagram showing the system optionally interfaced with the Internet;

FIG. 20 is a schematic diagram showing how continuous video capture can aid in repositioning ride sensors in a theme park ride;

FIGS. 21 and 22 each show an encoding table; and

FIG. 23 is a schematic view of a lens control system.

### DETAILED DESCRIPTION OF THE PREFERRED EMBODIMENT

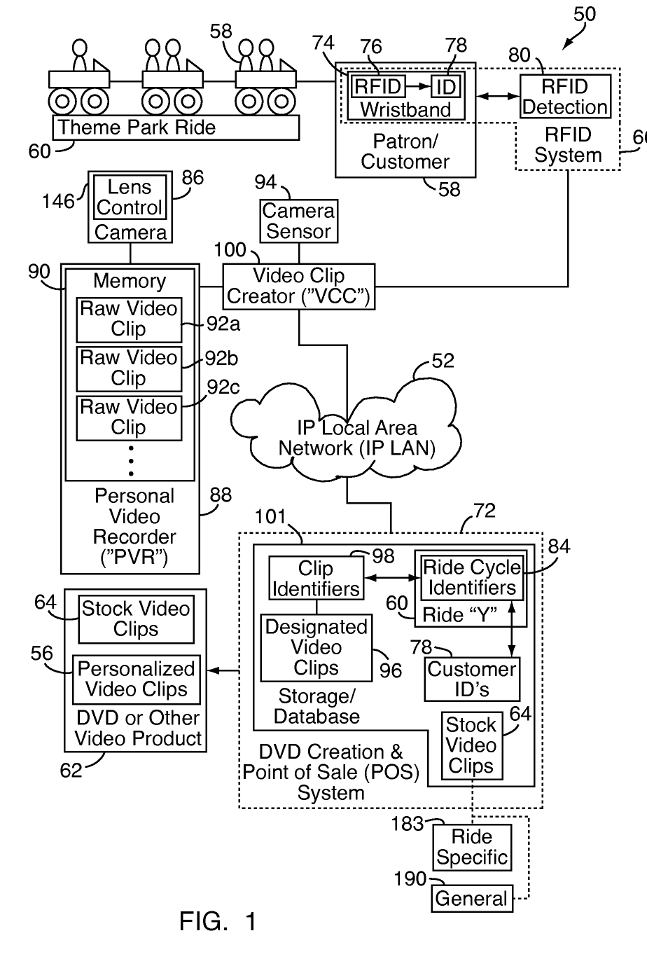

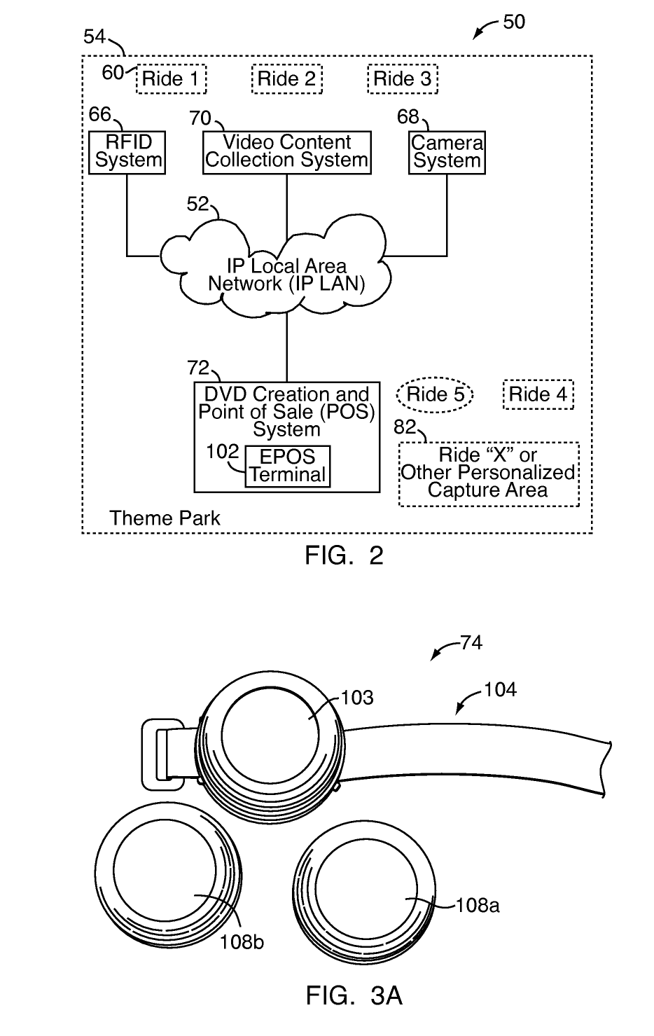

With initial reference to FIGS. 1 and 2 in overview, a system 50 for capturing and managing personalized video images is implemented on or in conjunction with an IP (Internet Protocol)-based local area network 52, which facilitates the exchange of data in the system 50 between a number of distributed sensor and data processing elements, as well as the control and management of such elements. In one embodiment, the system 50 is implemented in the context of an amusement park or theme park 54, for capturing personalized video content 56 of customers or patrons 58 as they visit designated rides or other attractions 60 in the theme park, and for creating a DVD or other video product 62 containing (i) the personalized video content 56 and (ii) professionally produced, “stock” video content 64 of the theme park 54. “Video content” refers generally to any multimedia data content, including video and still images, with or without associated audio content or other content, e.g., text, computer graphics, and the like. “Video product” refers to an assemblage of video content, provided in a form suitable for end-user/consumer use, e.g., DVD's, high definition formats such as HD-DVD™ and Blu-ray™, video tapes, computer-based or other digital storage, web-based content, and the like.

The overall purpose of the system 50 is to capture video content 56 of patrons 58 as they spend time in a theme park 54. The personalized or “custom” video content 56 for each patron is interspersed among stock video content 64 of the theme park, in a logically organized manner, to compile a personalized, high-quality video product 62 of the patron's day at the theme park 54. Typically, this is done in exchange for a fee, or it may be done as part of the admission fee for the theme park or on a promotional basis, e.g., as part of a vacation package.

The system 50 includes four main sub-systems working in concert to deliver the final product 62 to patrons 58. These include an RFID system 66 to track patron movements around the park 54; a camera system 68 to capture video images at designated locations around the park 54; a computer-based video content collection system 70 to collect and store personalized video clips 56 of patrons; and a DVD creation and point of sale (“POS”) system 72 to create the end product for sale to the patron. The sub-systems 66, 68, 70, 72 communicate over the LAN 52.

For each patron or customer 58 interested in obtaining a personalized video product 62 of the patron's day at the theme park 54, the patron is provided with (and subsequently wears) a wristband or other portable RFID enclosure 74 that contains an RFID device 76. The RFID device 76 contains a tag identifier or other customer identifier 78 that is at least temporarily uniquely associated with the patron in question. (The customer identifier 78 is a number or other alphanumeric value assigned to a customer of a theme park. The customer number can be deployed in a portable device via any number of different means, such as RFID, bar code, magnetic strip, or the like. The customer identifier is only significant on a specific day in a specific theme park, e.g., numbers can repeat on different days or in a different park.) The RFID device 76 is detected and read by an RFID detection sub-system 80 (e.g., RFID antenna and associated equipment) that is installed at each ride 60 or other personalized capture area 82. The RFID system 66 associates the detected customer identifier 78 with a “ride cycle number” 84 of the ride 60. A “ride cycle number” (or “event cycle number”) is an alphanumeric string or other code or identifier that uniquely identifies a particular event, i.e., something that happens within a particular time in a particular geographic locale. (In other words, the ride cycle number identifies, for example, a ride or location, and a particular occurrence, iteration, or run-through of that ride or location.) The ride cycle number is specific to the ride in question, and to an occurrence of the ride, e.g., the ride cycle number may be a number that is incremented every time the ride begins. A ride cycle number only has significance with one particular ride.

Each ride 60 or other personalized capture area 82 is provided with one or more cameras 86. The cameras 86 for each ride 60 are positioned at various strategic locations around the ride. The cameras 86 are “always on,” meaning that camera output is continuous during the course of a day or other designated time period when the theme park 54 is in operation. The video output from the cameras 86 is substantially continuously recorded to a local PVR/DVR (personal video recorder or digital video recorder) unit or other digital- or computer-base storage 88. For example, as shown in FIG. 1, the output of a camera 86 is routed to a nearby PVR unit 88, where it is stored in PVR memory 90 as a series of near-contiguous, raw video clips 92a-92c. (“Clip” refers to a short segment of video content. “Substantially continuous” recording means either continuous recording, or recording that is continuous but for time gaps required by the processor to break the continuous camera output into clips of a manageable size.) Photoelectric cells or other camera sensors 94 assist in identifying the start and stop times of designated video clips 96, that is, video clips containing content of interest, such as when as a ride vehicle travels past the camera 86. File identifiers 98 of the designated video clips 96 are matched to appropriate ride cycle numbers 84.

The functions of the camera sensors 94, PVR's 88, RFID system 66, etc., will typically be coordinated with respect to operation of a central preliminary video processing entity, such as a video clip creator (“VCC”) 100. The VCC 100 creates one designated clip 96 per camera 86 per ride cycle 84.

As indicated above, the cameras 86 are “always on,” thereby continuously generating video output during designated hours of theme park operation. Together, each camera 86 and PVR 88 generate a series of raw video clips 92a-92c that represent the continuous output of the camera 86, or a significant, substantial portion thereof. The raw video clips are generated regardless of whether there is any content of interest in the clip. In other words, clips 92a-92c are generated both of events of interest, such as a ride passing before the camera, and of other time periods where “nothing is happening.” The clips 92a-92c are stored in the PVR 88 until the PVR memory 90 is used up, at which time the PVR cycles back to the “beginning” of the memory 90 for storing newly generated clips. (In other words, the PVR acts as a continuous digital storage loop, with a duration that depends on the amount of local storage, but typically around 1 hour.) The VCC 100 and related components cross-reference the designated clips 96 and ride cycle numbers 84, which are in turn linked to customer identifiers 78. This is done before the PVR overwrites the locally stored raw video clips 92a-92c with new raw video clips. Thus, once the raw clips 92a-92c are stored in the PVR and the ride cycle is over, the VCC (and/or other components) moves the clips 96 that contain content of interest to more permanent storage, in association with the ride cycle numbers 84. By locally storing video in a continuous manner, this confers flexibility in terms of when to detect/read the RFID devices 76 and the location of the ride. For example, the RFID devices 76 could be detected at the beginning or end of a ride, or after the patrons leave the ride, with the system “looking back” into the raw clips 92a-92c for identifying designated clips 96. Also, instead of requiring ride or camera sensors to be placed in close proximity to the cameras, so that the cameras are in effect triggered by the sensors, the sensors can be placed away from the vicinity of the cameras, again, with the system looking back or forward in time through the clips 92a-92c based on how long it takes for the ride in question to travel from the camera to the sensor, or from the sensor to the camera.

Designated video clips 96 are stored in one or more databases or other digital storage 101. Identifiers 90 associated with the clips 96 are linked to the ride cycle numbers 84, as are the customer identifiers 78. Thus, for each ride 60, there will be a plurality of ride cycle numbers 84. For each ride cycle number 84, associated therewith are (i) a plurality of customer identifiers 78 (e.g., the identifiers of customers that were on the ride for the particular ride cycle) and (ii) a plurality of designated video clips 96, e.g., one for each camera associated with the ride 60.

As indicated above, there are three types of video clips in the system 50. These are the “raw” clips 92a-92c, the “designated” clips 96, and the “personalized” clips 56. To explain this hierarchy further, the raw clips 92a-92c represent the near-contiguous, always-on output of the cameras 86, as digitally recorded in a loop-like manner. The designated clips 96 are a subset of the raw clips, and represent those raw clips containing content of interest. The personalized video clips 56 are a subset of the designated video clips, and represent video clips associated with a particular patron 58. Thus, out of all the raw video clips digitally stored in the system 50, only a portion will contain content of interest, and only a portion of those will be relevant to a particular patron or customer 58.

When ready to leave the theme park 54, a patron 58 visits an electronic point of sale (“EPOS”) terminal 102 located in a retail store, kiosk, or elsewhere. An attendant places the patron's wristband 74 under a short range RFID reader, which reads the RFID device 76 for determining the customer's identifier 78. Based on the identifier 78, the system 72 creates a DVD or other video product 62 that is specific to the individual. The attendant takes payment for the DVD 62, provides the patron with a receipt, and, once it is complete, the DVD 62. The DVD 62 contains the personalized video clips 56 of the patron, which are interspersed among various stock video clips 64 of the theme park 54. For creating the DVD 62, as personalized clips 56 are generated for the patron, the DVD creation and POS system 72 inserts the clips 56 into the pre-recorded stock video content 64 at pre-determined points. The composite video product is stored in digital form in storage/memory 101. This can be done on an ongoing basis each time a personalized clip 56 is created, or when the patron's visit is complete and a DVD 62 is requested.

The system 50 may be configured in several ways as to how personalized video content 56 is interfaced with stock video content 64. In one embodiment, personalized video content 56 is simply “sandwiched” between stock video content 64, e.g., a stock introduction and conclusion 190. In another embodiment, there is stock content 183 for each ride 60, which contains a complete instance or run-through of the ride in question. For each patron, personalized video content 56 is in effect “written over” the stock content 183 at appropriate locations. If a particular patron doesn't visit a particular ride, then the ride may be omitted from the final product 62 entirely, or the final product may include the ride, but in stock form only.

The system 50 will now be described in more detail with respect to the various component portions of the system, and with reference to the attached figures and the attached appendices, which form a part of the present specification and are hereby incorporated by reference herein in their entireties.

As noted above, the system 50 includes four main sub-systems working in concert to deliver the final product 62 to patrons 58. These include the RFID system 66, the camera system 68, the video content collection system 70, and the DVD creation and POS system 72. The sub-systems operate over and in conjunction with an IP network backbone 52, for control and communication purposes.

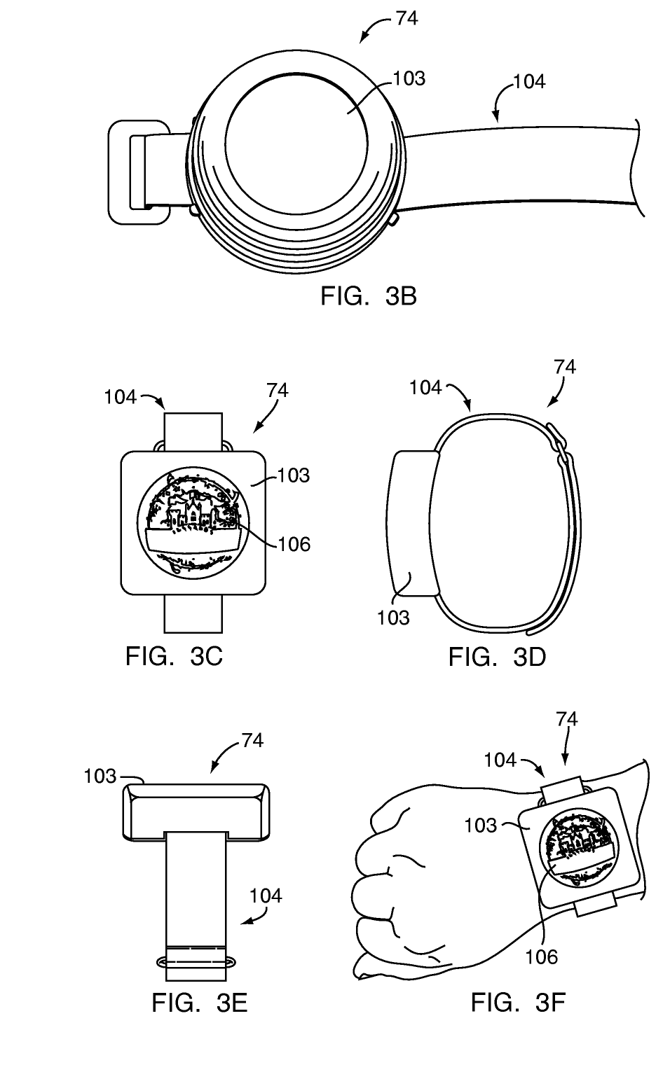

The RFID system 66 is used to identify patrons 58 when they visit designated rides 60 or other areas 82 outfitted with cameras for capturing personalized video content. Upon arriving at the theme park 54, individuals interested in obtaining a personalized DVD or other video product 62 are given RFID wristbands 74. Associated with each wristband 74 is a unique customer identifier 78. As patrons load onto a designated ride 60 (or at some other point before, during, or after the ride), RFID detectors 80 installed at the ride read the RFID devices 76 in the wristbands, to obtain the customer identifiers 78. All patrons on the ride are identified as being associated with the current ride cycle number 84 of the ride. Various embodiments of the RFID wristbands 74 are shown in FIGS. 3A-3F. As indicated therein, the RFID wristband 74 generally comprises a body 103 and a wrist connection means 104 operably connected to the body 103. The body 103 is a compact, water resistant housing that contains the RFID device 76. The body 103 may be round (see FIGS. 3A and 3B), square (see FIGS. 3C-3F), or otherwise. The body 103 may be provided with graphics 106 for advertisement and identification purposes, and/or they may be provided in different colors, e.g., see 108a, 108b in FIG. 3A. The wrist connection means 104 is used for temporarily but securely affixing the body 103 to a person's wrist, as shown in FIG. 3F. Numerous mechanisms are possible, including constriction straps or bands, buckle straps, hook-and-loop fastener-based straps, and the like. The wrist connection means 104 is attached to the body 103 in a conventional manner, such as through an aperture or through-slot provided in the body for that purpose, or through external-type strap loops or the like.

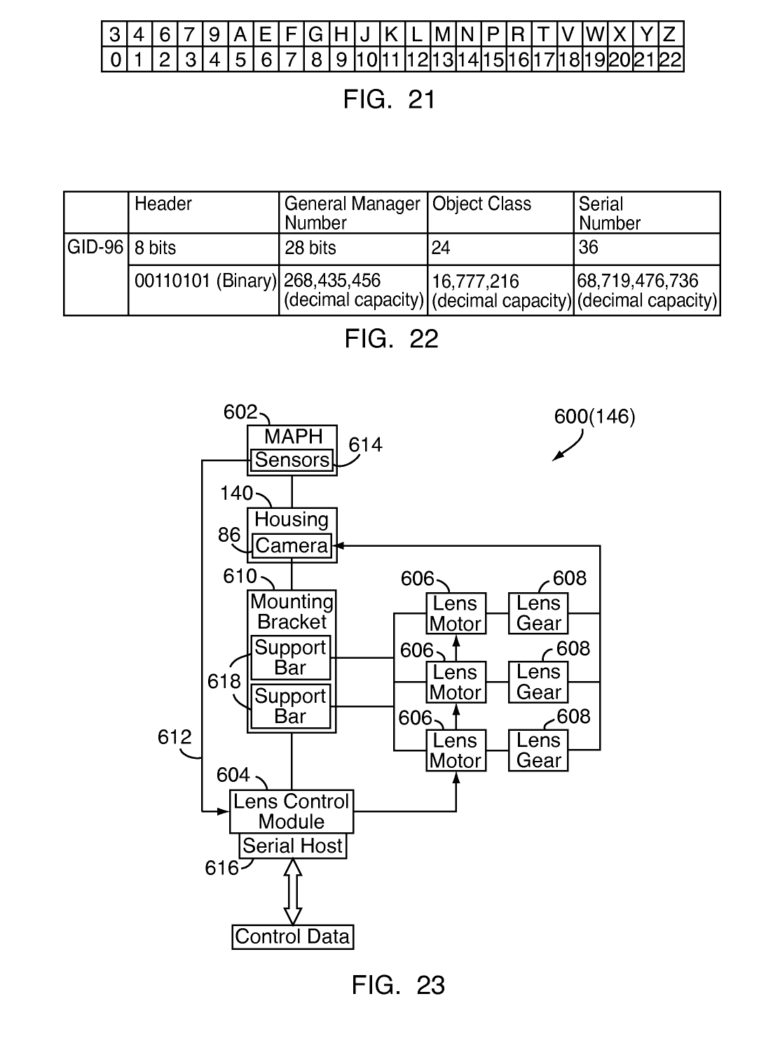

The RFID devices 76 may be programmed or encoded with customer numbers 78 in the manner described below, as relating to FIGS. 21-22.

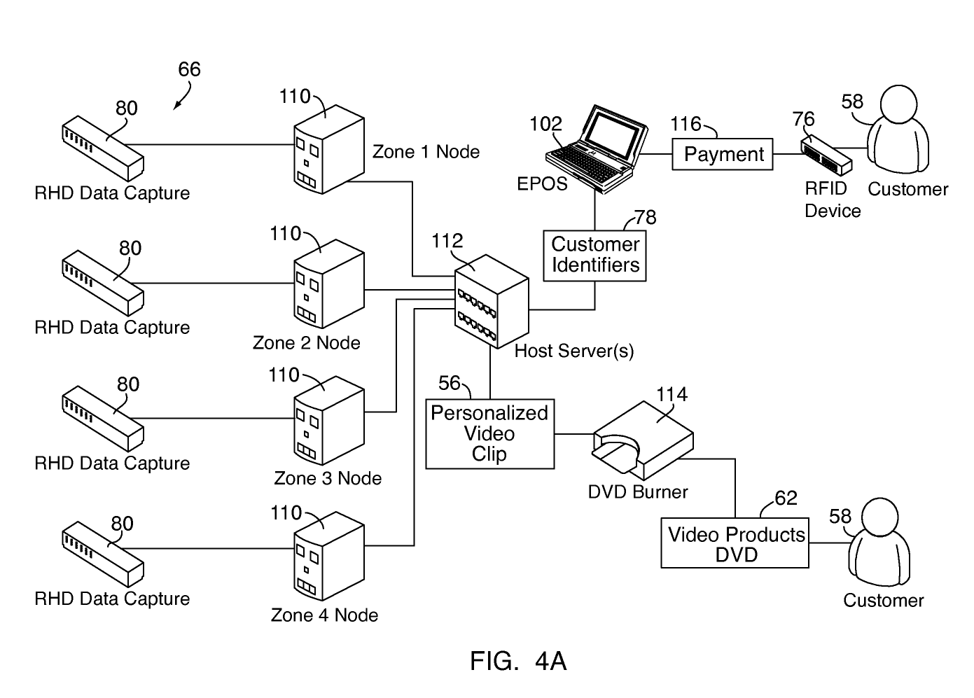

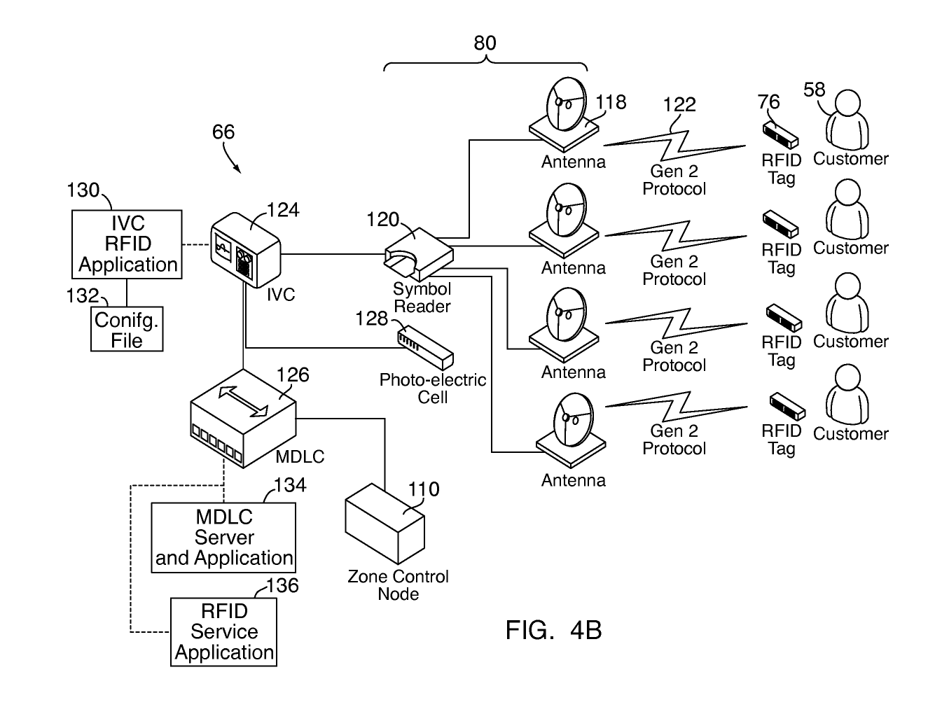

The RFID detectors 80 are used to detect and read patron wristbands 74 when they visit designated personalized capture areas 82 in the theme park 54. Overall, the purpose of the RFID system 66 is to capture unique customer identifiers 78 at designated locations around the theme park 54, and to timely convey the captured identifiers 78 to “upstream” components in the system 50 (e.g., the VCC 100) where such information is used. FIGS. 4A and 4B show the RFID system 66 in overview, both at the system level (FIG. 4A) and the component level (FIG. 4B). As indicated in FIG. 4A, a plurality of RFID data capture or detector sub-systems 80 are respectively connected to various zone nodes 110 in the network 52. The zone nodes 110 are centralized points of the network 52, each designated for a different zone or area of the theme park 54. In other words, for control and data transfer purposes, the theme park 54 may be logically divided into various zones, each containing one or more personalized capture areas 82. Although only one RFID detector sub-system 80 is shown in FIG. 4A, it may be the case that a number of detector sub-systems are connected to each zone node 110. Typically, there will be one RFID detector sub-system 80 for each personalized capture area 82. The zone nodes 110 are in turned connected to one or more network host servers 112, which coordinate data transfer in the network 52. The server 112 is in turn directly or indirectly interfaced with the EPOS terminal 102, and to a DVD burner sub-system portion 114 of the DVD creation and POS system 72. As indicated in FIG. 4A, when a customer 58 with an RFID device 76 returns to the EPOS terminal 102 at the end of the day, and in exchange for payment 116, the EPOS terminal 102 transfers the customer identifier 78 from the RFID device 76 to the host server 112. Based on the customer identifier 78, the DVD burner sub-system 114 creates a DVD 62 that includes the customer's personalized video clips 56.

FIG. 4B shows the RFID system 66 at the component level, for the case of one network node. As indicated, the system 66 includes an RFID antenna 118 at each ride 60 or other personalized capture area 82. The antennas 118 are in turn connected to one or more RFID readers 120, which drive the antennas 118 for detecting customer identifiers 78 in a wireless manner, e.g., using the Gen 2 EPC RFID protocol 122 (also known as the ISO 180006B protocol) or another RFID protocol. The antennas 118 are configured to operate within a designated distance, e.g., 2.5 meters, for detecting nearby RFID devices 76.

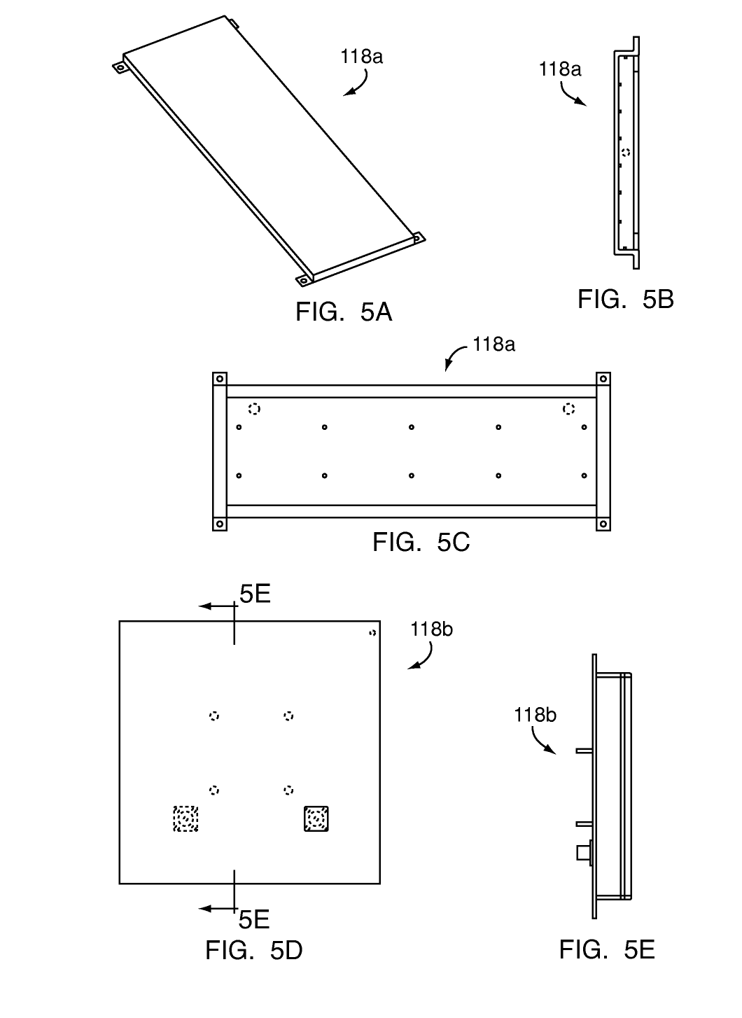

The RFID reader 120 may be a Symbol Technologies® XR480 RFID reader, or a unit with a similar capacity and functionality. Further information is available at http://www.symbol.com/products/rfid-readers/rfid-technology and related web pages, which are hereby incorporated by reference herein in their entireties. An example antenna 118a is shown in FIGS. 5A-5C. The antenna in FIGS. 5A-5C is an aluminum frame antenna, for operation in the 840-960 MHz bands. Another example antenna 118b is shown in FIGS. 5D and 5E. Antenna 118b is a dual CP antenna for UHF RFID, for operation in the 840-960 MHz bands. (Example dimensions in FIGS. 5B-5E are in millimeters.) Such antennas are available from RFTechnics Ltd. of Sheffield, UK. The exact antennas used will depend on the characteristics of the personalized capture area 82, including the spatial relationship between where the antennas can be placed and where the RFID devices 76 are likely to be located when patrons go on a ride. For example, for each ride 60, antenna type and placement will typically be based on considerations of range (e.g., what is the range for covering the designated area without the possibility of false reads from patrons outside the ride), safety (e.g., the antennas cannot be too close to the ride's path of travel), and RFID device detection reliability, e.g., the antennas should be placed at locations with a maximized chance of reading the RFID devices but with a minimized risk of detecting patrons that did not actually go on the ride cycle in question. Antenna selection and placement is typically assessed on a ride-by-ride basis in light of correlating the above-noted factors, in an empirical manner. That being said, for many rides, and especially linear path-based rides such as roller coasters, it is often the case that antennas are optimally placed when arranged in a portal or semi-portal configuration (that is, surrounding the ride pathway), in a tunnel or other passageway through which the ride vehicle passes after it has started, when it is no longer possible for patrons to exit the ride vehicle or ride area without actually going on the ride.

The RFID reader 120 is connected to an IVC (in vehicle computer) unit 124 or other local controller, which is in turn connected to an MDLC (mobile data link controller) server 126 by way of an Ethernet cable or other line. (As discussed in more detail below, the MDLC server 126 acts as the interface between the IVC units 124 and the remainder of the system 50, e.g., a zone control node 110.) The IVC unit 124 is housed in an enclosure along with the RFID reader 120 and any other equipment (e.g., an Ethernet hub) required for interfacing the IVC unit 124 with the RFID reader and/or the MDLC server or other upstream network component. The IVC unit 124 acts as a localized controller for supporting and controlling the RFID readers 120, the cameras 86, and related sensors, such as a photoelectric ride sensor 128 or other sensor for initiating operation of the RFID reader 120. For this purpose, an IVC RFID edge-server software application 130 runs on the IVC unit 124. The RFID edge-server application provides the following functionality: control of the RFID reader 120 and antenna 118, including provision of an application programming interface for the RFID reader-specific driver; control of certain localized sensors used as part of the system 50; aggregation and filtering of RFID data 78; real time interface of the RFID data to the MDLC server 126, e.g., over Ethernet or GPRS, and in a specified format; filter/logic functions, such as removing duplicate customer identifiers; logging functions for monitoring and diagnostic purposes; and monitoring and control of the RFID reader hardware 120, to self-initiate corrective actions in the case of equipment malfunctions. The IVC unit 124 may be configured to operate based on one or more re-configurable process parameters or rules. For example, one process parameter may specify a grouping time, which determines the delay period for grouping detected customer identifiers together prior to sending them as a batch of data to the MDLC server 126. The process parameters may be contained in an IVC configuration file 132 stored on or otherwise accessible to the IVC unit 124. Upon start-up, the IVC unit 124 accesses the configuration file 132, and operates based on the process parameters specified in the file. The configuration file 132 is remotely accessible for modifying the process parameters from a central location, and without having to access the IVC unit 124 physically.

The IVC unit 124 is a Linux-based processing unit with Ethernet, serial, and GPRS communication capabilities, along with extensive I/O functionality. The IVC unit 124 may be, for example, an OWA2X series IVC from Owasys company of Vizcaya, Spain. The IVC unit provides advanced localized processing capability in a rugged and weatherproof package, to withstand weather conditions in an outside environment. (The IVC unit is enclosed in a housing, but nevertheless may be subject to temperature extremes, moisture exposure, and vibration from ride vehicles.) Instead of using IVC units, other options include a remote server unit connected to the RFID readers via Ethernet, or running communication software applications directly on the RFID readers. As should be appreciated, both options obviate the need for providing IVC units. However, the former increases the risk of a single point of failure, and the latter fails to provide the monitoring, control, and corrective-action functionality offered by the IVC units. In other words, the IVC unit controls the RFID reader so that if any issues arise the IVC unit is able to remotely report on and initialize the reader should it be required.

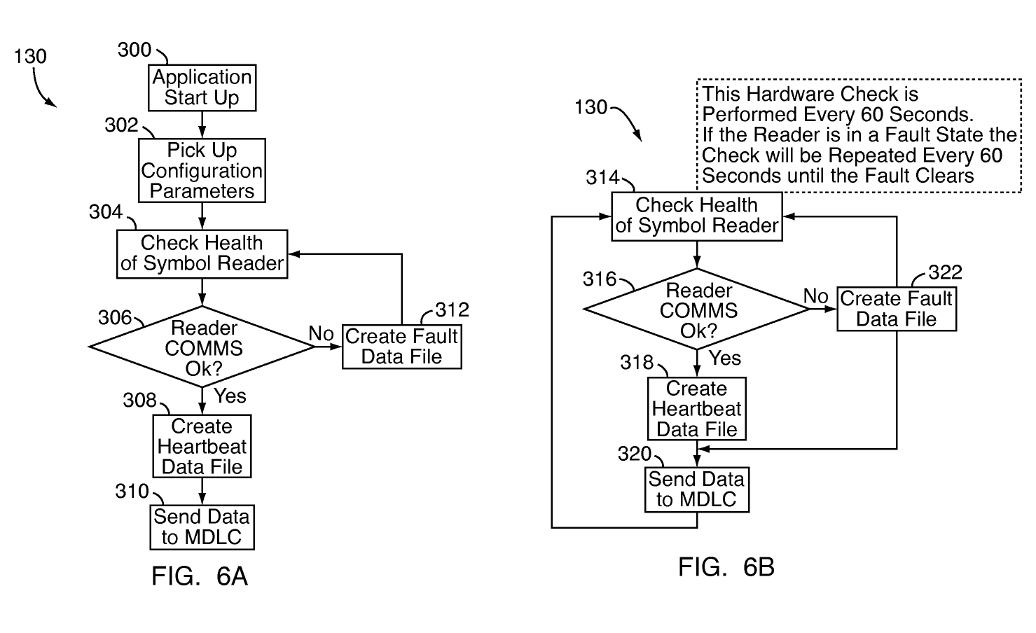

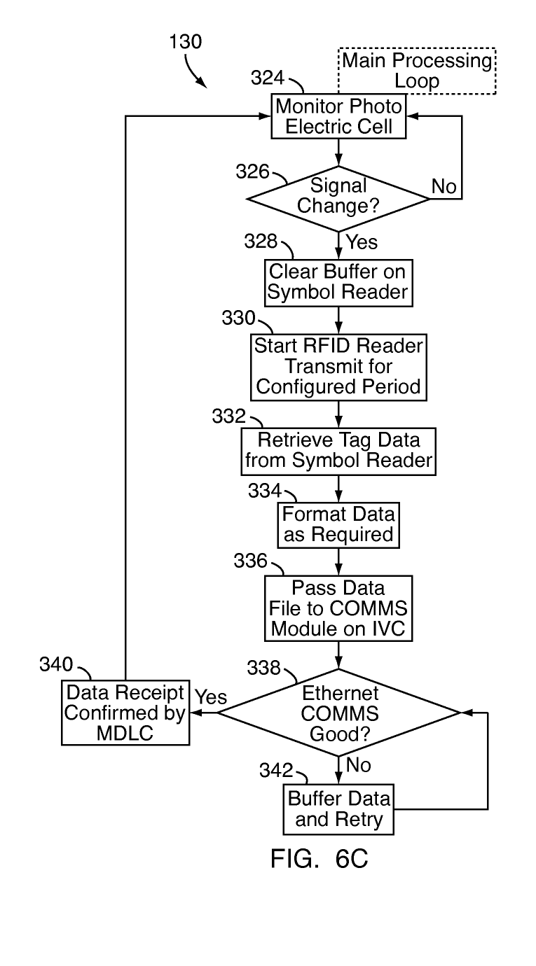

FIGS. 6A-6C show how the IVC RFID application 130 operates, according to one embodiment of the present invention. FIG. 6A shows the start-up procedure, which commences at Step 300. At Step 302, the IVC RFID application 130 accesses the configuration parameters in the configuration file 132. At Step 304, the IVC RFID application 130 checks the health of the RFID reader 120, e.g., through an exchange of control signals generated by the RFID reader driver or otherwise. If the RFID reader is determined to be within desired operational parameters, as determined at Step 306, the IVC RFID application 130 creates a heartbeat data file at Step 308. The heartbeat data file contains information relating to the operational status of the RFID reader 120. This information may be transmitted to the MDLC server at Step 310, otherwise the main processing loop (as shown in FIG. 6C) is carried out. If the RFID reader is determined to be outside desired operational parameters, as determined at Step 306, a fault data file is created at Step 312, which contains data relating to the operational status of the RFID reader 120, in this case fault data. With reference to FIG. 6B, if the RFID reader 120 is in a fault state, or at other designated regular instances (e.g., every 60 seconds), the IVC RFID application 130 periodically checks the health of the RFID reader 120, as at Step 314. If the RFID reader is determined to be within desired operational parameters, as determined at Step 316, the IVC RFID application 130 writes data to the heartbeat data file at Step 318. (A heartbeat data file is created if needed.) This information may be transmitted to the MDLC server at Step 320, otherwise the main processing loop (as shown in FIG. 6C) is carried out. If the RFID reader is determined to be outside desired operational parameters, as determined at Step 316, fault data is written to the fault data file at Step 322. (A fault data file is created if needed.)

If the RFID reader 120 is not in a fault state, and thereby within desired operational parameters, the IVC RFID application 130 main processing loop is carried out as shown in FIG. 6C. At Step 324, the IVC RFID application 130 monitors a photoelectric cell 128. The photoelectric cell 128 is interfaced with the IVC unit 124, and is positioned proximate to a designated area where the RFID devices 76 are to be detected, such that the photoelectric cell 128 is tripped when patrons 58 (wearing the wristbands 74) are within the designated area. For example, for a given ride 60, the photoelectric cell 128 could be placed near the RFID antennas 118 such that its output beam is broken by the ride vehicle when the ride vehicle comes within range of the antennas. If the photoelectric cell 128 is tripped, as determined at Step 326, a buffer portion of the RFID reader 120 is cleared at Step 328. At Step 330, the RFID reader 120 is controlled to transmit (e.g., wirelessly read any within-range RFID devices 76) for a period designated in the configuration file 132. At Step 332, the IVC RFID application 130 retrieves the data read by the RFID reader 120, e.g., the customer identifiers 78 that the RFID reader obtained from the RFID devices 76. At Step 334, this data is formatted according to a desired format. At Step 336, the formatted data is transferred to a communication module portion of the IVC unit 124. At Step 338, the IVC RFID application 130 determines whether the IVC unit's Ethernet connection (or other communication connection) is within desired operational parameters. If so, the data is transferred to the MDLC server 126, which may confirm receipt at Step 340. At Step 342, if the Ethernet connection is not functioning within desired operational parameters, the IVC RFID application 130 attempts to re-transmit the data. Data may be transmitted between the IVC unit and MDLC server 126 according to any number of different formats. Typically, however, the data will include one or more of the following: a site identifier (e.g., an identifier associated with the theme park where the IVC unit is located); a location identifier (e.g., an identifier associated with the location of the IVC unit in the theme park); the data read from the RFID device(s), e.g., customer identifier; the RFID device type or model number; information relating to the activity type; the date and time the RFID device was read; RFID device battery level; a received signal strength indicator or other signal data; and the IP address of the RFID reader.

The MDLC server 126 acts as the interface between the RFID system 66 and the remainder of the system 50, e.g., a zone control node 110. The MDLC server 126 is a microprocessor-based device (e.g., a Windows®-based server computer), on which run an MDLC server application 134 and an RFID service application 136. The MDLC server application 134 manages communications with the IVC units 124, including handling all re-tries, session links, and the like. It also provides control and management functions for the IVC units, such as firmware downloads, status checks, and reporting. The server application 134 also generates output to external systems using MSMQ (queue-based) communications in an XML format. The RFID service application 136 serves to collect and coordinate all RFID device data (e.g., customer identifiers) received from the IVC units, including the aggregation of RFID device data from multiple IVC units for a particular ride. The service application 138 also performs detailed application logging operations for diagnostic purposes, converts the RFID device data from .CSV to .XML format, and controls the monitoring of external hardware such as the RFID readers 120 and IVC units 124.

The camera system 68 is used for capturing video clips in a controlled manner. For each ride 60 or other personalized capture area 82, the camera system 68 includes at least one video camera 86, at least one PVR unit 88 (there may be one or more cameras per PVR unit), and one or more camera sensors 94. The cameras are positioned at locations around the ride 60 where it is desired to capture designated video clips 96. Camera output is recorded to the PVR unit 88, in what is in effect a continuous digital loop. The PVR units 88 may be standalone electronic units, or they may be PVR/DVR applications that reside on computer terminals or other general-purpose processor units. For example, the PVR units may utilize a video processing program such as LEADTOOLS®—see http://www.leadtools.com for generating the raw video clips. If “machine vision” cameras are used, such as those mentioned below, a program such as Common Vision Blox™ from Stemmer Imaging company may be used—see www.imagelabs.com/cvb/. The camera sensors 94 (e.g., photoelectric cells or other sensors) assist in identifying the start and stop times of when a ride vehicle passes the camera's field of view. This allows the video content collection system 70 to identify the designated video clips 96 (e.g., the clips containing content of interest, for inclusion in video products 62 as personalized video clips 56), and to store them in association with a ride cycle number 84 for future use.

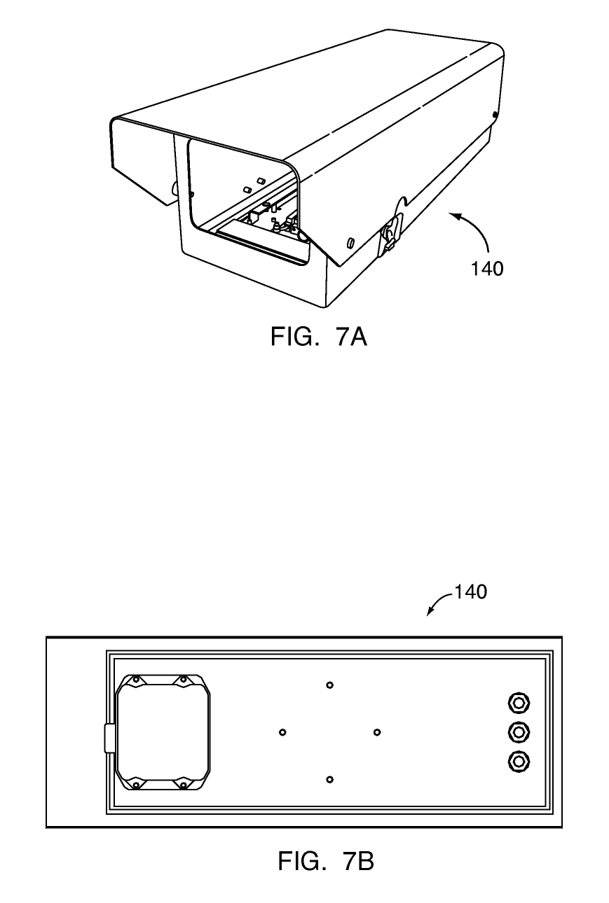

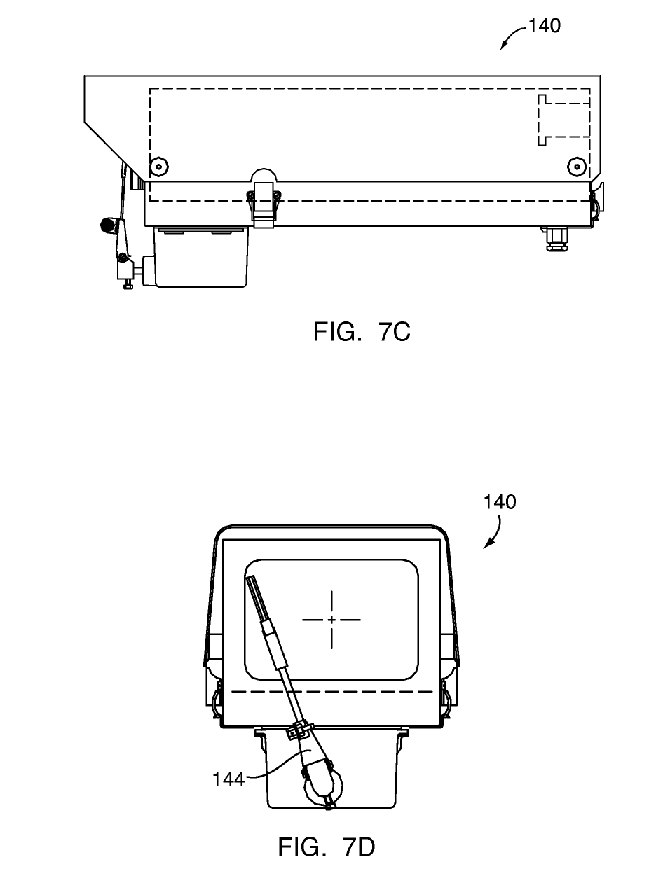

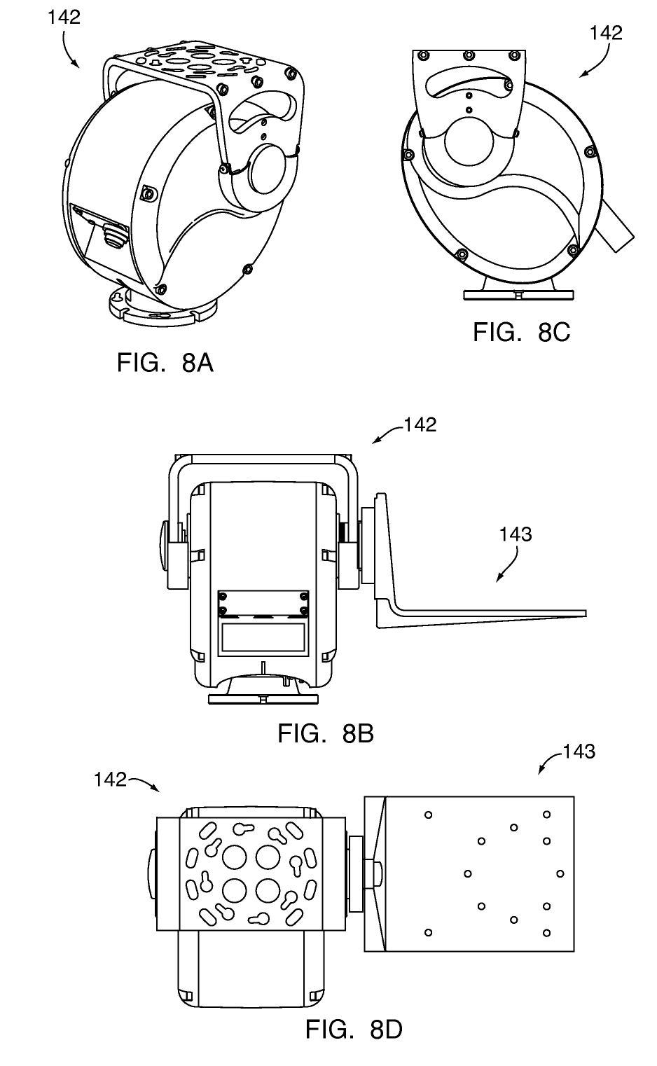

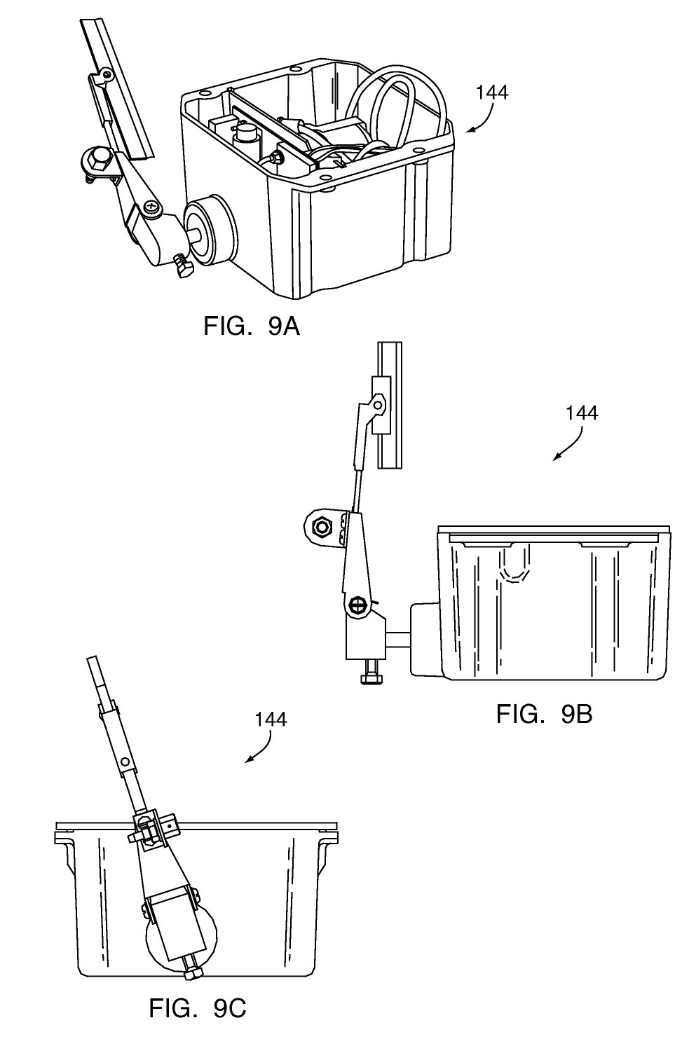

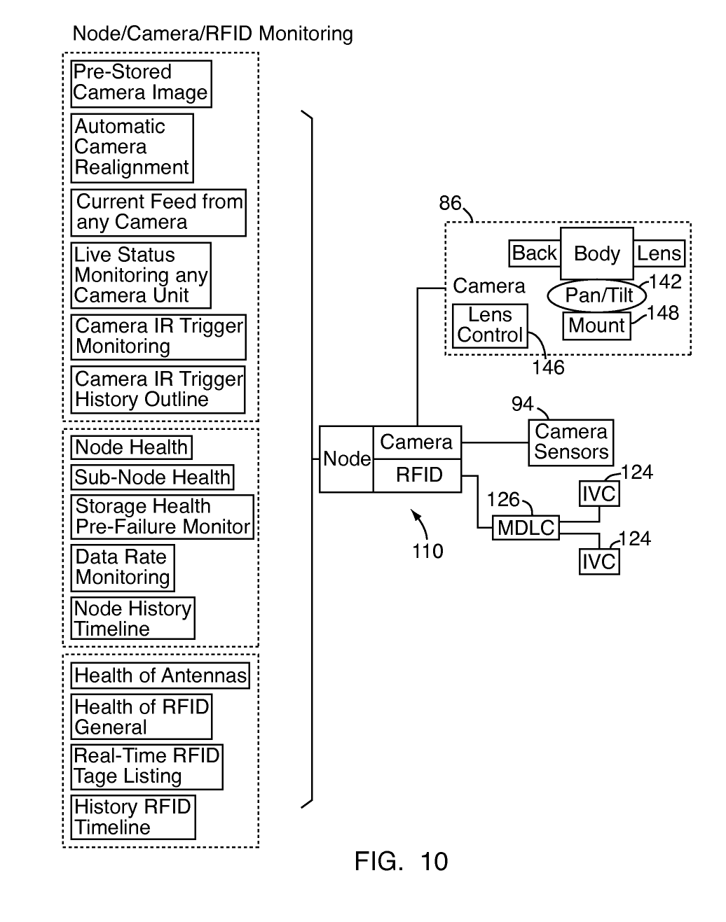

Cameras 86 are mounted in standard housings 140, such as a Dennard type 515/516/517 camera housing as shown in FIGS. 7A-7D. These housings accommodate a wide range of camera/lens combinations, and include insulated camera platforms (where applicable) with longitudinal adjustment. Additional features include window heaters, thermostats, three cable glands, and full sunshields. The cameras 86 are also typically provided with electrically controllable pan/tilt heads 142, and with anti-weather wipers 144. Suitable pan/tilt heads 142 include the type 2000/2001/2006 pan and tilt head available from Dedicated Micros, as shown in FIGS. 8A-8D (see www.dedicatedmicros.com). These pan and tilt heads are weatherproof, have a pan movement of 5° to 350°, a tilt movement of +20° to −90°, and can be operated upright or inverted. An optional side mounted platform is shown at 143. Suitable wipers 144 include the type DW wiper, as shown in FIGS. 9A-9C, also available from Dedicated Micros. The wiper units provide a complete window wash/wipe system in conjunction with the housings 140, including washer jet functionality and self parking wiper arms. The wiper units are constructed from pressure die-cast aluminum alloy, are powder coated and stoved with stainless steel wiper arms and fittings, and offer environmental protection to BS.EN.60529 level I P65. Camera mounting structures 148 are custom designed for each camera location and are constructed on site. The cameras 86 are standard video cameras with a custom lens control system 146. The cameras may have different fps (frames per second) ratings, for capturing video content at different rates. Typically, this will depend on the characteristics of the ride in question, and on where the camera is placed with respect to the ride. For example, a higher-fps camera (e.g., 50 fps) may be appropriate for capturing video content of a fast-moving ride vehicle, to capture detail, whereas a lower fps camera (e.g., 25 fps) may be appropriate for capturing video content of a slow-moving or stopped ride vehicle, where no detail is lost in using a lower fps setting, to reduce the storage size of the resultant clip. Suitable video cameras include the Allied Vision Technologies AVT Marlin IEEE 1394 digital camera, and the Allied Vision Technologies AVT Pike IEEE 1394b digital camera. The custom lens control system 146 facilitates changing of the camera units without having to change the lens control system, and allows for advanced control and sensing operations relating to camera function, such as light exposure readings. The custom lens control system 146 is explained in more detail below, in regards to FIG. 23. The cameras and associated camera equipment are powered using a power distribution and surge protection device, to supply clean power to the units.

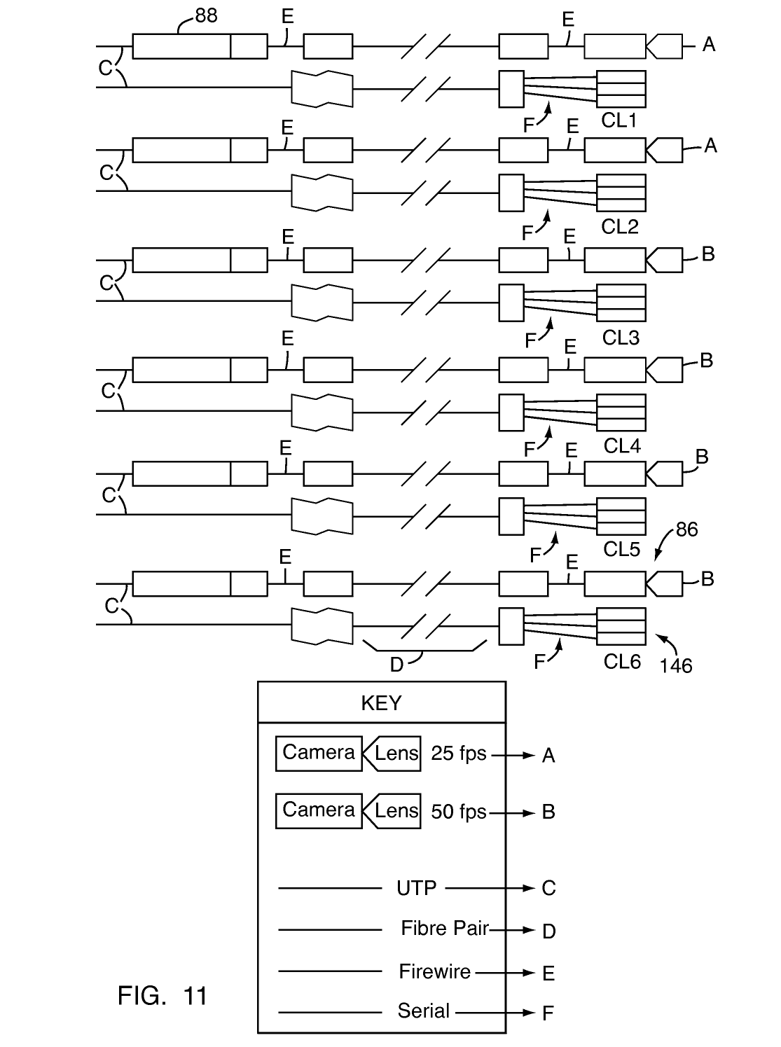

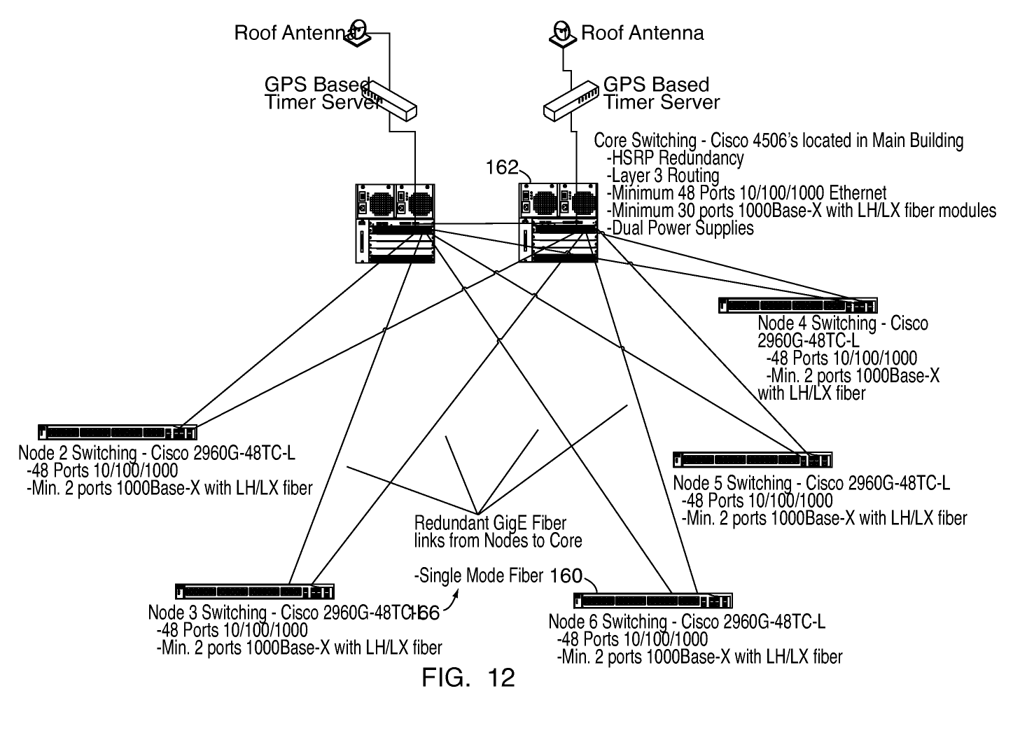

The network 52 comprises a data center 112 and node locations 110 physically connected via fiber optic cable or other communication lines. All components in the system 50 that are part of the data capture, transfer, processing, and control infrastructure (e.g., cameras, RFID systems, and the like) are physically cabled to the node locations. A conceptual schematic drawing of the node structure is shown in FIG. 10. A schematic drawing of the connections between individual camera locations and the nodes is shown in FIG. 11. All of these system components are connected via the IP network 52, which is built on top of the fiber and physical infrastructure. A diagram of the IP LAN 52 is shown in FIG. 12. As indicated, the LAN 52 includes a number of network switches 160, e.g., Cisco Systems model 2960G-48TC-L switches, one for each node. These are in turn connected via optical fiber lines to one or more core network switches 162, e.g., a Cisco Systems Catalyst 4506 switch. A GPS-based time server 164 may be used for establishing a common system clock. Also, redundant optical fiber links 166 may be provided for communication backup purposes or otherwise.

As should be appreciated, instead of an optical, etc.-based network 52, the network 52 may be, in whole or in part, a wireless network, wherein data is communicated over the network using wireless transceivers or the like that operate according to designated WLAN (wireless LAN) or other wireless communication protocols. For example, in one embodiment the system includes one or more base stations distributed about the theme park (or perhaps one centralized base station), which wirelessly communicate with transceivers positioned at each camera location, for the exchange of video data and control signals.

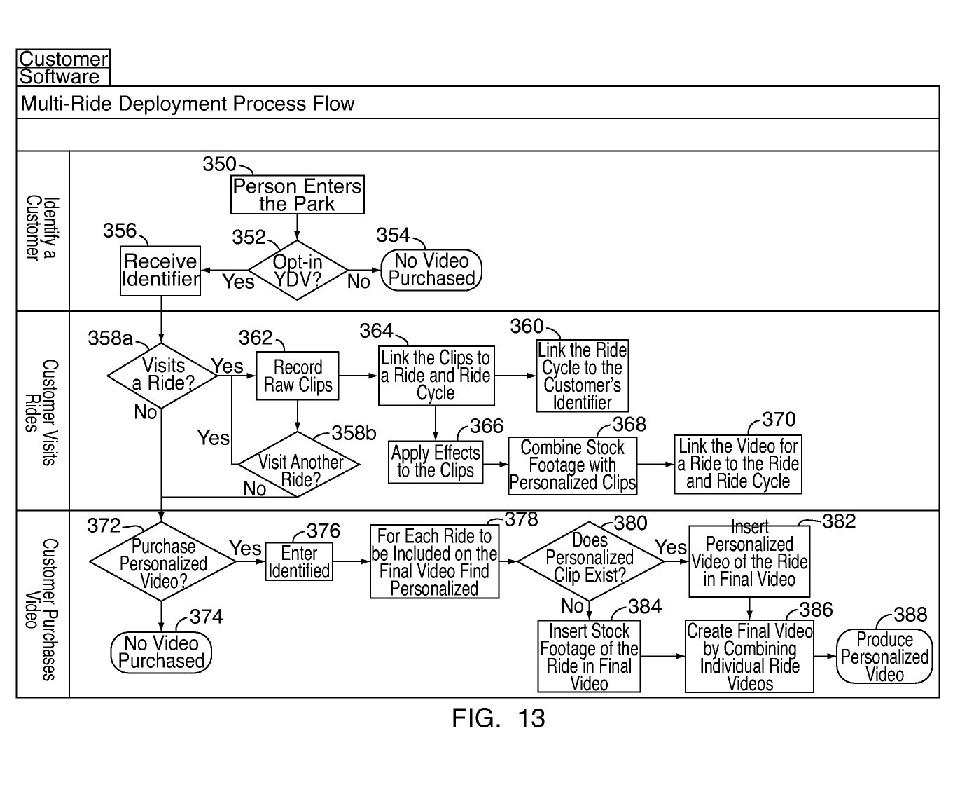

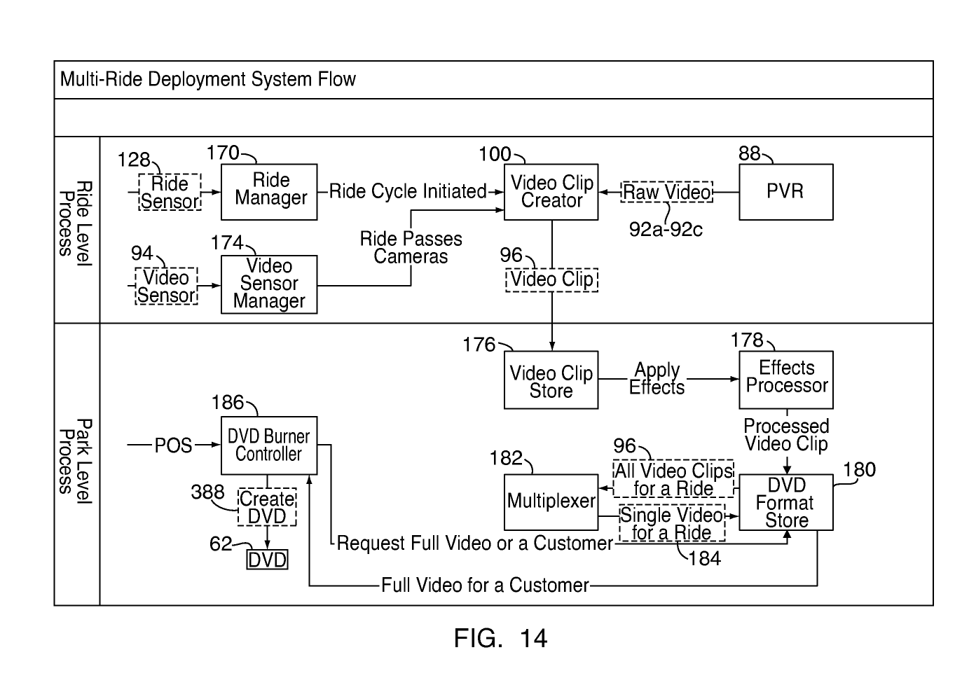

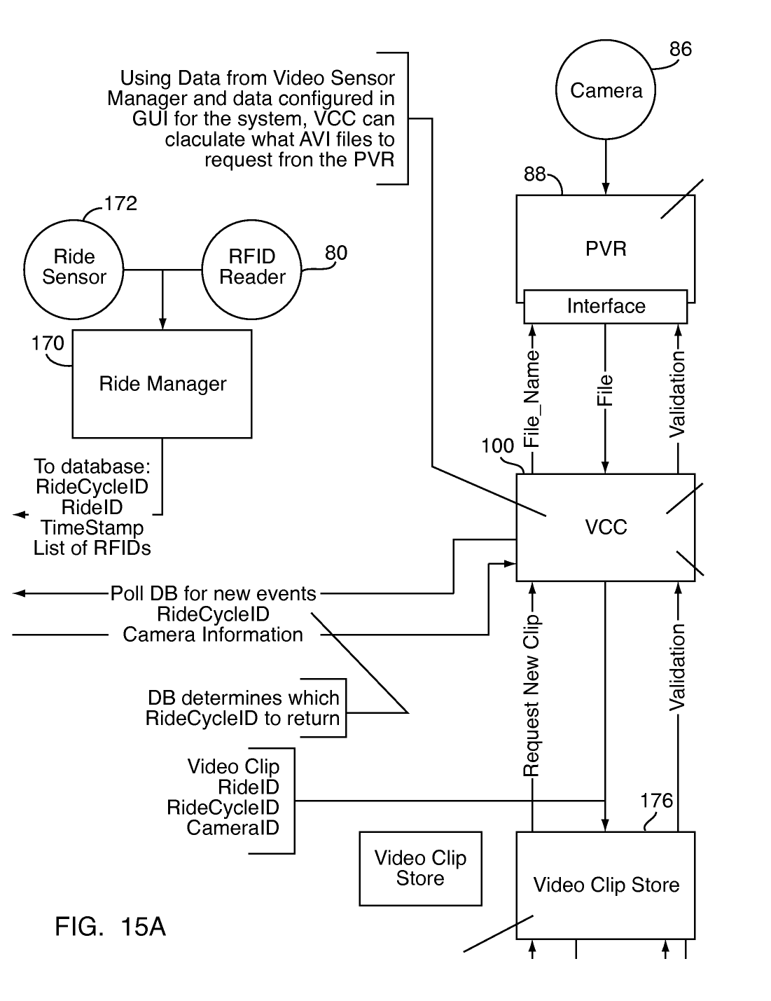

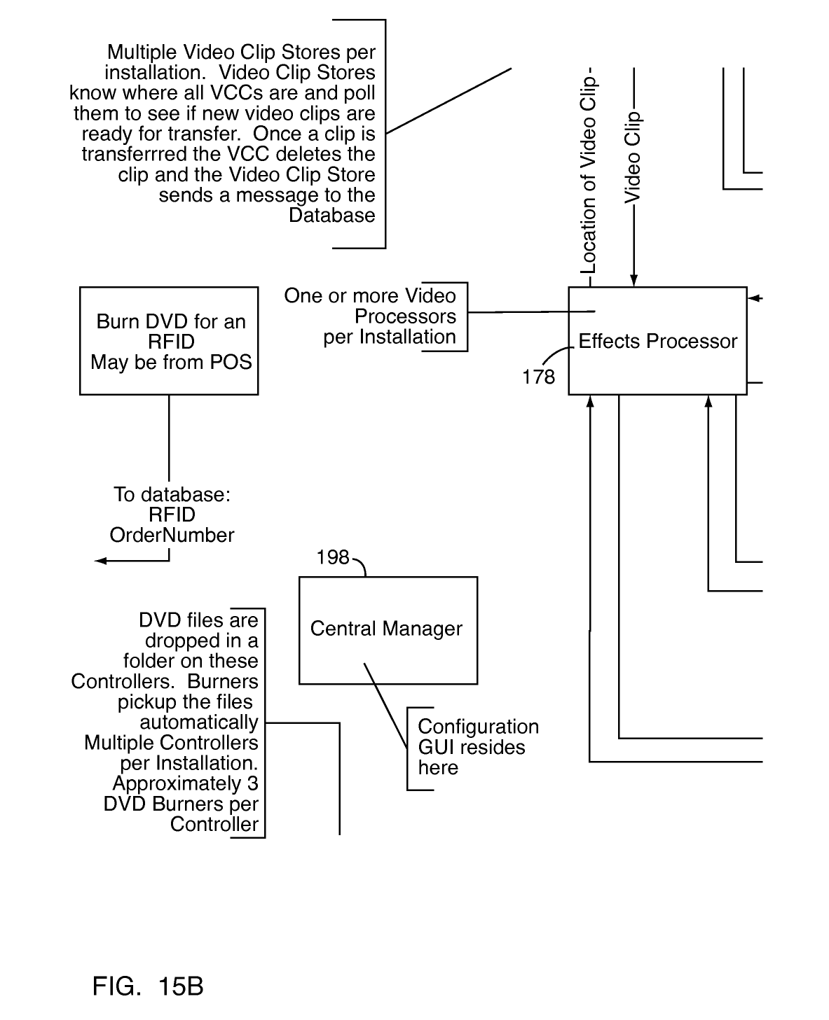

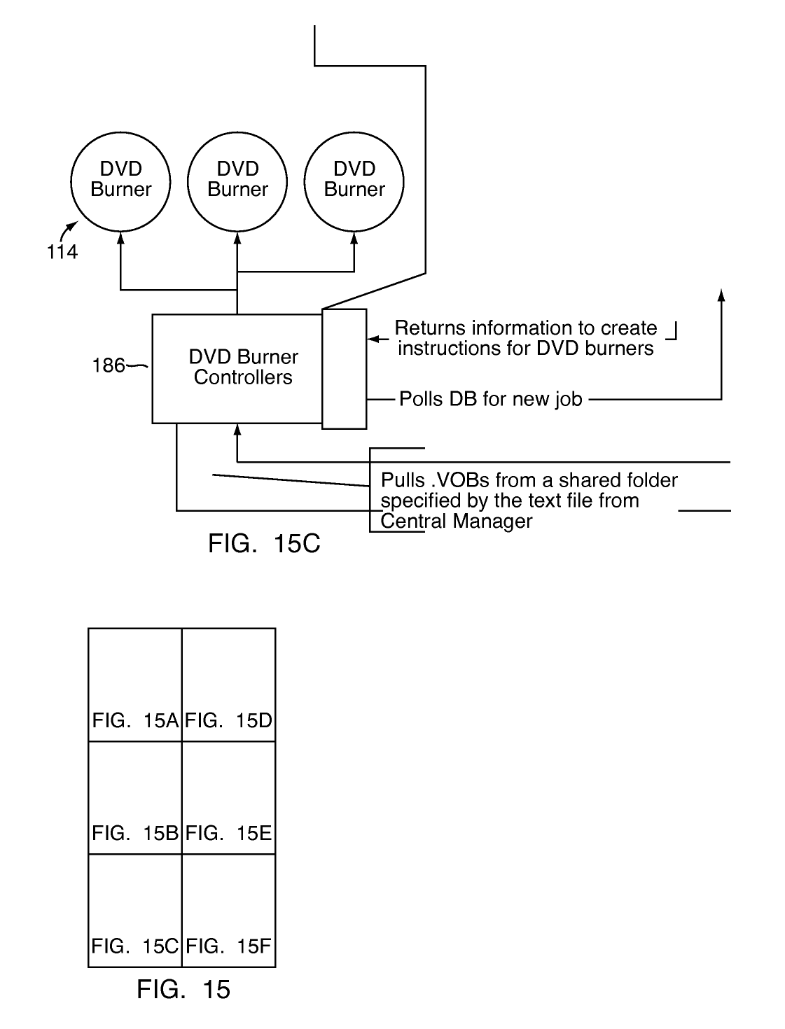

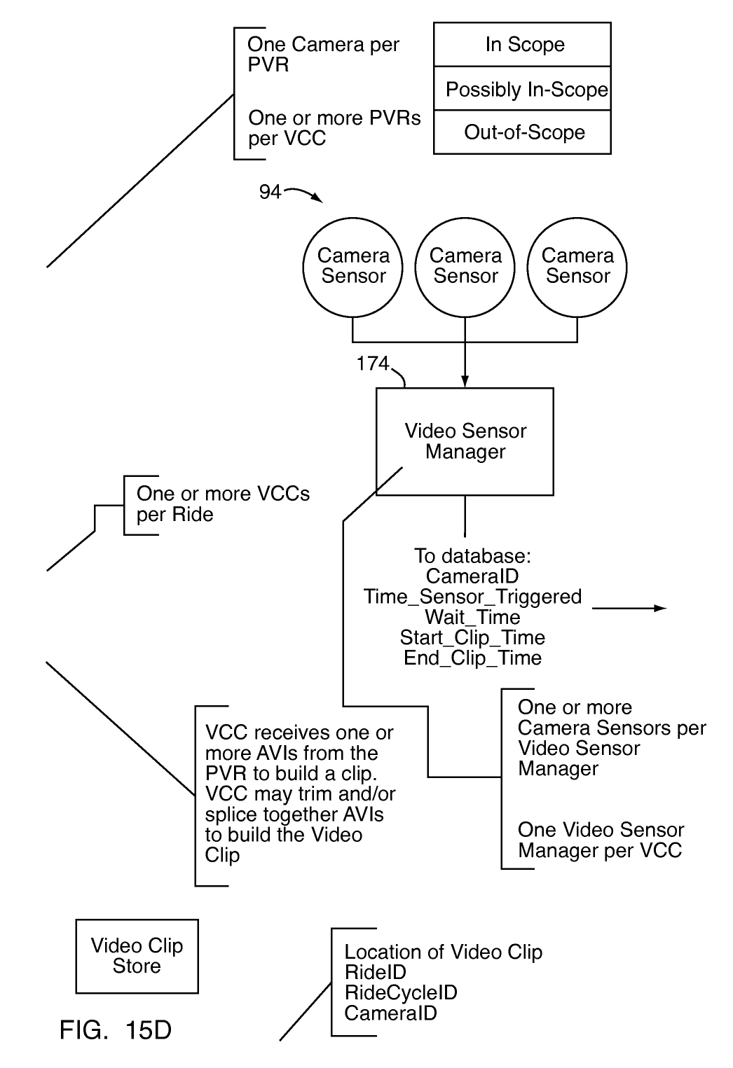

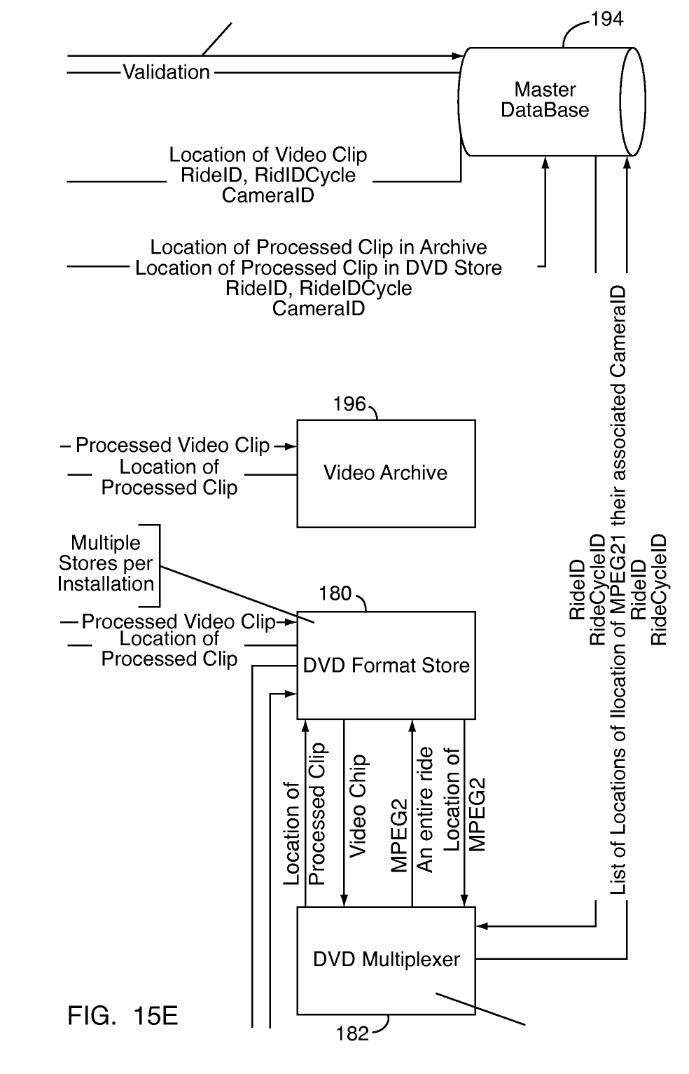

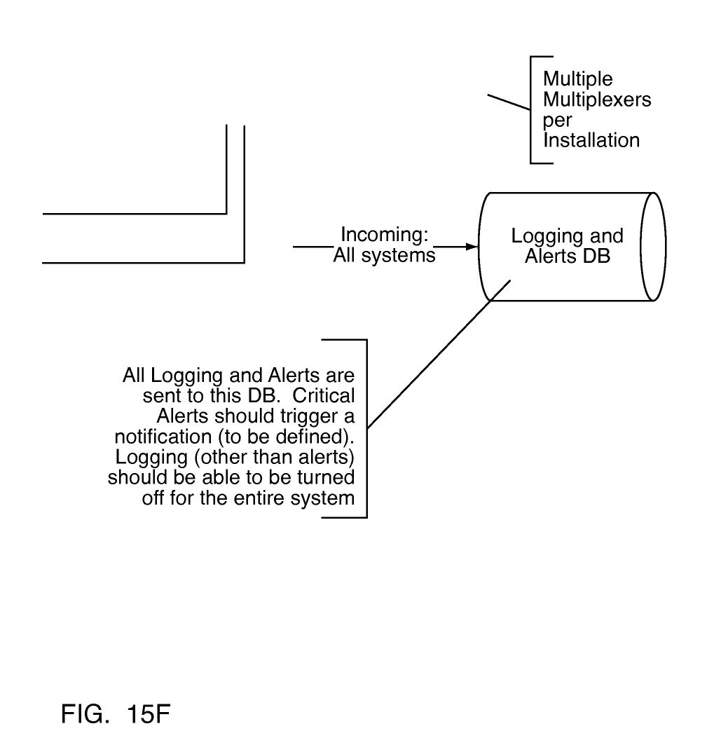

The video content collection sub-system 70, DVD creation sub-system 72, etc. form the functional core of the system 50 for managing the flow of information, building the proper associations between customer identifiers 78, ride cycle numbers 84, and designated video clips 96, processing the video clips (including applying effects), archiving the video clips, formatting them for DVD burning, and burning the DVD's 62. These sub-systems are constructed as a software overlay on top of the IP LAN 52. The software overlay is formed from a collection of software modules that run on different computers or other electronic units, connected via the network infrastructure 52, that are all coordinated to effectively produce the final product 62. An overview of the software modules and flow of information will now be discussed with reference to FIGS. 13-15. FIG. 13 summarizes the operational characteristics of the system 50 as it relates to a patron's physical interaction with the system and the process for a patron to use the system for purchasing a personalized video product 62. FIGS. 14 and 15 relate more specifically to the individual software modules in the system 50 and their functions.

In the system 50, the process for producing a personalized video product 62 is summarized in FIG. 13. At Step 350, a theme park patron enters an amusement park or theme park 54 that is equipped with the system 50. At the entrance to the park, or at some other location (e.g., travel agency or hotel), the patron is provided with the option to opt-in to the system 50, as at Step 352, for the production of a personalized DVD 62. For example, the opt-in transaction may be carried out at an EPOS terminal 102. If it is decided not to opt in, the process ends at Step 354. (The individual may be given other opportunities to opt in, by returning to the EPOS terminal 102 or another location where it is possible to opt in at a later time.) Otherwise, the patron is provided with an RFID wristband 74 or other device that contains a unique customer identifier 78, as at Step 356. For example, instead of an RFID wristband 74, it is possible to use magnetic cards, barcode-type cards, or the like. The RFID wristband 74 allows the system 50 to link designated video clips 96 back to the particular patron. At this point, it is also possible to specifically link the patron to the assigned customer identifier 78, e.g., by entering the patron's name in a database that also contains the identifier 78, in case the RFID wristband 74 is lost. The patron may be required to pay in advance for the DVD product 62 before being provided with an RFID wristband 74. Alternatively, payment is collected just prior to producing the finalized video product 62.

After being provided with an RFID wristband 74, the patron 58 travels about the theme park 54 in a normal manner, visiting various rides 60 and other personalized capture areas 82 that are part of the system 50. Each time the patron 58 goes on a designated ride 60 (or visits designated locations 82), as at Steps 358a and 358b, the system 50 associates the ride occurrence 84 of that ride with the patron's customer identifier 78, as at Step 360. The ride is equipped with one or more cameras 86. At Step 362, on an ongoing basis, the output of the cameras is digitally recorded as a series of raw video clips 92a-92c. (Note that the raw clips 92a-92c are generated regardless of whether a particular patron of the system, or any patron for that matter, actually goes on the ride.) During or after the ride cycle, the system identifies one or more designated clips 96, based on the camera sensors 94 or otherwise, which contain content of interest, including views of the patron. At Step 364, the system links the designated clips 96 to the ride cycle number 84.

The system 50 is optionally configured to apply effects to the designated video clips 96, as at Step 366, such effects relating to brightness, color, length, fade, and the like. At Step 368, pre-determined sections of professionally produced video clips 64 of the ride are overwritten with the designated video clips 96, resulting in a high quality mix of personalized video and stock footage. At Step 370, the system then links the mixed or combined video clips to the unique ride cycle number 84. Alternatively, instead of combining the designated clips 96 and stock footage 64 in close temporal proximity to the ride cycle in question, these steps may be carried out once it is requested that a personalized DVD 62 be created.

The patron 58 continues going on different rides 60, in a normal manner as is typical for a theme park visitor. At the end of the day, the patron returns to the EPOS terminal 102 or other designated location for returning the wristband 74 and obtaining a personalized DVD 62. At Step 372, the patron decides whether to purchase a personalized DVD 62, if this decision has not already been made. If not, the patron returns the wristband 74, the process ends at Step 374, and the patron is not provided with a DVD 62. If so, the patron's customer number 28 is entered into the system, as at Step 376. This may be done, for example, by using a local, short range RFID reader to read the patron's wristband 74. The system cross references the customer identifier 78 to the database 101, for determining the ride cycle numbers 84 associated with the customer identifier 78. At Step 378, for each ride that the patron went on, the system finds the personalized video clips 56 of that ride cycle. As determined at Step 380, for each ride that the patron went on, the patron's personalized video clip 56 from the particular ride cycle 84 is used for the DVD 62, as at Step 382. For each ride that the patron did not go on, as determined at Step 380, the stock video content 64 of that ride is used by itself for the DVD 62, as at Step 384. Alternatively, video content of such rides may be omitted from the DVD 62. Once all the personalized video clips are found by the system, the video clip files for the DVD 62 are formatted and stored in electronic format, as at Step 386. The DVD or other video product 62 is burned or otherwise created at Step 388, and is provided to the patron for taking home.

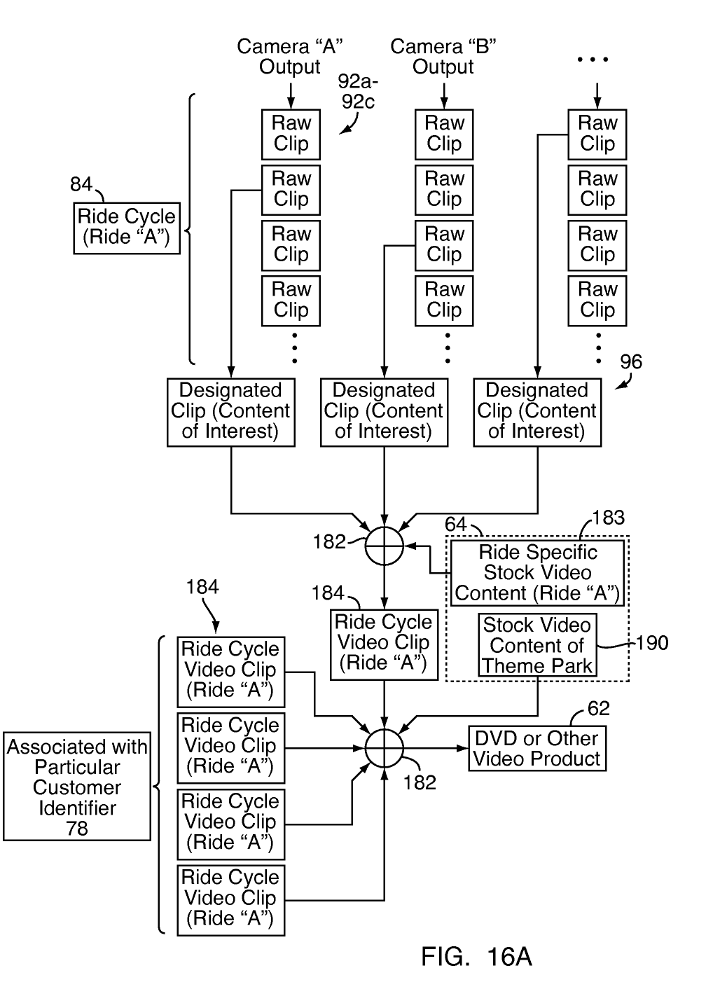

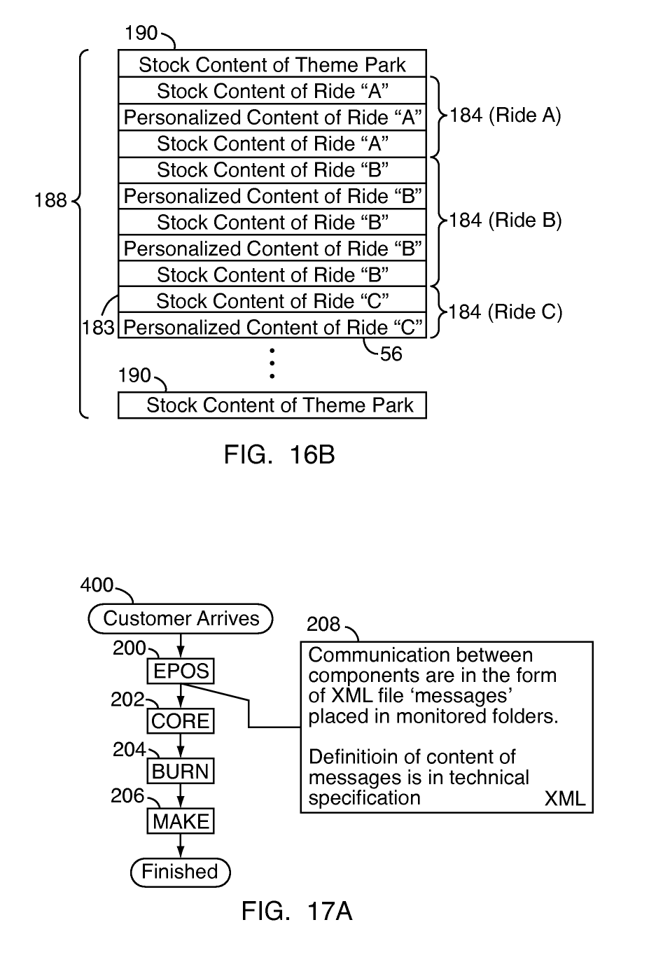

FIGS. 14, 16A, and 16B show the system 50 in overview, as relating to the video clip creator (VCC) 100 and other software modules in place for collecting and processing information relating to patron tracking and video clip creation and management. (Explanation hereinafter is given with respect to one ride 60. However, as should be appreciated, each designated ride 60 or other personalized capture area 82 in the theme park 52 is provided with such functionality, which may be dedicated for use with one ride, or for use with multiple rides.) On an ongoing basis, the PVR 88 digitally stores the continuous output of one or more cameras 86 as a series of near-contiguous raw video clips 92a-92c. For example, each clip 92a-92c may be an AVI (audio video interleave) file, MPEG file, or other discrete digital video file, typically containing video content with a length of from about 10 seconds to about 30 seconds. A ride manager module 170 determines that a new ride cycle 84 has started and when that event occurred. This may be done in cooperation with a ride sensor 128 whose output is functionally connected to the ride manager. For example, the ride sensor 128 may be a photoelectric cell placed near the ride vehicle's pathway, such that when the ride commences, the photoelectric cell is tripped, indicating that the ride cycle has started. A video sensor manager 174, working in conjunction with the camera sensors 94, detects when the ride passes the cameras 86 placed about the ride. The VCC 100 receives information from the ride manager 170 and video sensor manager 174. The VCC 100 uses this information to determine which of the raw video clips 92a-92c stored in the PVR 88 contain content of interest. These clips, i.e., the designated clips 96, are retrieved from the PVR 88. The VCC 100 processes the designated clips 96 for producing one video clip per camera per ride cycle. A video clip store 176 (e.g., a storage device) obtains the video clips 96 from the VCC 100, and holds them until they are ready to be processed by an effects processor 178. The effects processor 178 applies various effects (brightness, color, fade, etc.) to the video clips based on the ride they came from and the cameras on the ride they were recorded from. Once effects are applied, the video clips are sent to a DVD format store 180, which is the temporary holding/storage location of video that is in-process. A video multiplexer module 182 takes all of the designated video clips 96 for a ride cycle 84 and seamlessly integrates them with ride-specific stock video content 183 to create a single ride cycle video clip 184 for the ride cycle 84. The ride cycle video clip 184 is sent to the DVD format store 180. Based on customer identifier 78, a DVD burner controller 186 identifies all of the ride cycles 84 that a patron was on and creates a final sequence 188 of video clips to deliver to storage. The final sequence 188 includes all the ride cycle video clips 184 associated with the patron's customer identifier 78, in addition to additional stock video content 190 of the theme park generally, e.g., an introduction and conclusion. (Optionally, the final sequence 188 includes stock footage of the rides 60 that the patron did not go on.) At Step 388, a video product 62 is created that contains the final sequence 188.

If a patron goes on the same ride a number of different times, the system 50 may be configured to include only the last instance in the video product 62. Other schemes are possible, such as including more than one instance, or creating a montage of the various instances.

The modules 100, 170, 174, etc. will now explained in more detail with respect to FIGS. 15 and 4B. Module functionality is described in additional detail below.

As noted above, the MDLC 126 serves to collect and coordinate RFID device data received from the IVC units, including the aggregation of RFID device data from multiple IVC units for a particular ride. (Typically, there is one MDLC 126 per system node 110.) Thus, the MDLC 126 interfaces with its IVC units 124, consolidates data, and deposits one XML file for each ride cycle 84 into a shared network folder. The XML file contains the ride name, all the customer identifiers in the ride cycle, a sequence ID, and possibly additional data.

There is one ride manager module 170 per node 110. The ride manager module 170 functionally interfaces with the MDLC 126 and/or IVC RFID application 130. The ride manager 170 polls the shared network folder, retrieves XML files as soon as they are available, and updates a master database 194. The ride manager 170 creates appropriate rows in a “ride manager” table in the database 194 for the new ride cycle, and assigns a ride cycle number 84 to the ride cycle. The ride cycle number is an incremented number with a field length of at least 28 characters. Other types of identifiers may be used for identifying the ride cycles. The ride manager 170 also creates a stack of cameras in a “sensor triggers” table in the database, based on how many cameras are associated with the ride in question. The cameras are associated with a given ride cycle number. For example, if there are five cameras in ride “X,” there will be five rows in the “sensor triggers” stack. Each of these cameras is associated with a predefined unique IP address in a camera table.

The video sensor manager 174 interfaces with the camera sensors 94. There is one video sensor manager per ride 60. The video sensor manager 174 consumes a public sensor cluster interface, which in turn raises an event each time a camera sensor 94 is triggered, and passes the IP address and trigger time back to video sensor manager 174. The video sensor manager is able to map a given IP address to a particular camera. The video sensor manager finds the first camera with the given IP address and a “status=0” in the “sensor triggers” table and updates the status to 1. This signifies that the sensor 94 for this camera and ride cycle number has been triggered. This enables the system to manage rides where a new ride cycle can begin even before the previous ride cycles are complete. The video sensor manager 174 is also responsible for managing configuration settings for each camera, such as wait time and the duration of the raw video clips 92a-92c, and calculates start clip and end clip time of the designated video clips 96 based on trigger time of the camera sensors 94. This information is written to the database 194.

Each ride cycle number 84 identifies a particular instance of a ride's operation. Thus, the ride cycle identifies the ride and the particular instance of the ride. When a ride starts, the RFID devices 76 on the ride are detected (thereby obtaining the customer identifiers 78) based on the triggering of a ride sensor 128, and a ride cycle number is generated for that instance of the ride. As the ride vehicle travels along its designated pathway, it goes past the camera sensors 94. Typically, there are two camera sensors associated with each camera, to in effect detect when the ride vehicle enters the camera's field of view and when the ride vehicle leaves the camera's field of view. It is possible for the camera sensors to be located before or after the actual camera location, in which case they identify an offset time. Thus, for a particular camera/sensor pair, the designated clip is deemed to start at the time the ride vehicle goes past the first camera sensor, plus or minus “X” seconds depending on vehicle speed and the spatial relationship between the camera field of view and sensors, and to stop at the time the ride vehicle passes the second sensor, again, plus or minus “X” seconds depending on vehicle speed and the spatial relationship between the camera field of view and sensors. The start and stop times identify the segment of video (e.g., the designated video clip) to pull out of the PVR for the particular ride cycle. Once the designated video clip is pulled out of the PVR, the time values are irrelevant, since the video clip is stored with respect to ride cycle number.

The video clip creator (VCC) 100 creates a single video clip per camera per ride cycle. There is one VCC 100 per ride 60. The VCC 100 fetches AVI files (e.g., raw video clips 92a-92c) matching specified criteria at fixed intervals from each PVR 88, and creates an appropriate video clip for each camera/PVR for each ride cycle based on various parameters. For this, the VCC 100 periodically polls the database 194 to determine the video clips to be retrieved from each PVR for a given ride 60 (e.g., the designated video clips 96), in consideration of a designated wait time. Then, the VCC requests the files of a given time frame from the PVR in question. The PVR passes a file list to the VCC, which the VCC uses for purposes of retrieving the files through another method call. Upon receiving the files, the VCC 100 uses LEADTOOLS or another video-processing program to slice and combine the video clips in order to prepare a single AVI file (e.g., video clip) for the given ride cycle. Once a single video clip is created for a particular camera for a particular ride cycle, the VCC 100 updates the database 194 accordingly.

The video clip store 176 comprises one or more storage devices, which are used in conjunction with a given number of rides 60. The video clip store 176 retrieves the AVI files from different VCC units 100 and stores the files in memory.

The effects processor 178 processes the AVI files produced by VCC (one file per camera, ride ID, and ride cycle number). There is one effects processor 178 per ride 60. Processing may involve applying brightness, contrast, and color balance on each video clip. The effects are pre-customized manually using LEADTOOLS® and the data is stored in a centralized location on the file system for further reuse. The effects processor applies effects and converts the file into MPEG-2 file format before storing it in the DVD format store 180 and a video archive 196.

The DVD format store 180 acts as a repository for the MPEG-2 files created by the effects processor 178, as well as for .VOB files created by the DVD multiplexer 182. A VOB file (“DVD-Video Object” or “Versioned Object Base”) is a container format for DVD-video media. It contains the actual video, audio, subtitle, and menu contents in stream form. There are one or more DVD format stores per theme park.

The DVD multiplexer 182 is configured to assemble and process the various video clips for burning to a DVD 62. More specifically, multiplexing is the process of building a project in an authoring program so that it can be burned to DVD and read by a standard DVD player. A typical multiplexing process involves combining an MPEG-2 video file, an AC3 or MP3 audio file, and a subtitle file together into an MPEG-2 program stream. The MPEG-2 program stream is converted into a DVD image output, which comprises VOB and IFO files, for burning to a DVD 62.

The DVD burner controller 186 builds various .JRQ files required by the DVD burning software, which is provided by the vendor of DVD burner hardware 114. Therefore, the main functionality of the DVD burner controller 186 is to visit the database 194 periodically, determine the customer identifier 78 with respect to the most recent sale, and prepare the .JRQ files required to burn the DVD 62 for that sale.

The system 50 may include a central manager application 198, which provides a GUI-based computer environment for user management of one or more of the system elements described herein.

The DVD multiplexer 182, DVD format store 180, etc. may be configured to creates DVD's 62 using VOB replacement, which reduces the amount of time required for preparing the DVD's.

To explain further, replacement is a faster way to prepare a DVD from prepared video files and new video files. In general, a DVD video file is an MPEG-2 program stream presented in a .VOB file. When a DVD is created all the source material is multiplexed. The end result is one .VOB file. Multiplexing takes time. If some of the video is already in MPEG-2 program stream format, then it is already in .VOB format. A way is available to chain multiple .VOB files together so that only new video need be multiplexed, thus saving on time and processing.

By way of technical background, the video information on a DVD is contained in a number of .VOB files, with a limit of approx 1 GByte for a .VOB file. A typical movie is usually longer than 1 GByte. To allow for this, a series of .VOB files are created and marked as being in the same title on a DVD. Typically the main feature is in one title, and extra material (bloopers real, etc.) is in other titles. An .IFO file contains the information that tells the DVD reader which files to play and in what order. When a .VOB files completes, the .IFO file knows what action to take next. This is sometimes a menu, but can also be the next .VOB file in the title. Any .VOB file can be replaced in the file structure by a different .VOB as long as they are the same length in seconds and have the same parameters, e.g., 16/9 aspect ratio.

For creating DVD's using .VOB replacement, instead of only moving to a new .VOB file at the 1 GByte mark, the system moves between .VOB files when moving from stock video to new video. This is done by first creating the DVD file structure on a hard disk using, in addition to the stock video, additional stock video that is the same length as the video to be inserted, e.g., the personalized video clips. The length of the additional stock video is pre-determined on a ride-by-ride basis, based on the ride-camera relationship. For example, if it is known that a ride vehicle travels at a certain speed past a camera, it is possible to determine how long the ride vehicle will be in the camera's field of view for each ride cycle.

The video product is split into one track with many separate .VOB files. By creating the DVD structure, the relevant .IFO files are also created. The DVD is thereby in a pre-prepared state. Subsequently, the following steps are carried out: (i) capture the new video (e.g., designated/personalized video clips); (ii) multiplex the new video with sound to produce an MPEG2 program stream; (iii) rename to the correct name, e.g., “VTS_{—}01_{—}2.VOB” (video file 2 of title 1); (iv) copy this file over the existing file in the DVD file structure; and (v) repeat as often as there is new video; and (vi) burn the DVD.

The VOB replacement method is more generally characterized as involving the following steps. First, a video product template is generated. The template includes stock video clips and a plurality of template video clips. The template clips have a time length that corresponds to respective projected time lengths of the designated video clips, i.e., clips associated with a customer identifier. Second, the video product is created by replacing the template clips in the template with the designated video clips. In the case where the video product is a DVD, the template clips are in one or more .VOB files, and the designated video clips are in one or more separate .VOB files. The DVD is in part created by replacing the .VOB files of the template clips with the .VOB files of the video clips associated with the customer identifier.

Regarding fault tolerance, there are two alternative approaches available for addressing network or hardware downtime that causes the SQL server database 194 to be unavailable. (This situation is considered critical only for sub-systems/modules that interact with the database 194 for storing or retrieving data.) For handling situations where the database 194 is not available, a first approach is to use MSMQ and implement a mechanism to queue the data into MSMQ messages. The database server can retrieve these messages from time to time, check the database connection, and update the database when the connection is restored. A second approach is to drop the data into XML files on the local machine. A Windows®-based service would poll for such XML files and attempt to update the database when the connection is restored.

The DVD creation and EPOS sub-system 72 ties together traditional retail purchasing transactions with the creation and delivery of the personalized video products 62. Unlike most retail transactions, there isn't a specified list of “items” available for purchase, but rather a customized item that is created “on the fly” for the patron to purchase. This requires two functions. The first is to identify the patron via the patron's RFID wristband 74, retrieve the personalized video clips 56 associated with the patron's customer identifier 78, and build a DVD 62 from the clips 56 and the stock footage 64. The second involves payment processing and matching the payment to the personalized DVD 62.

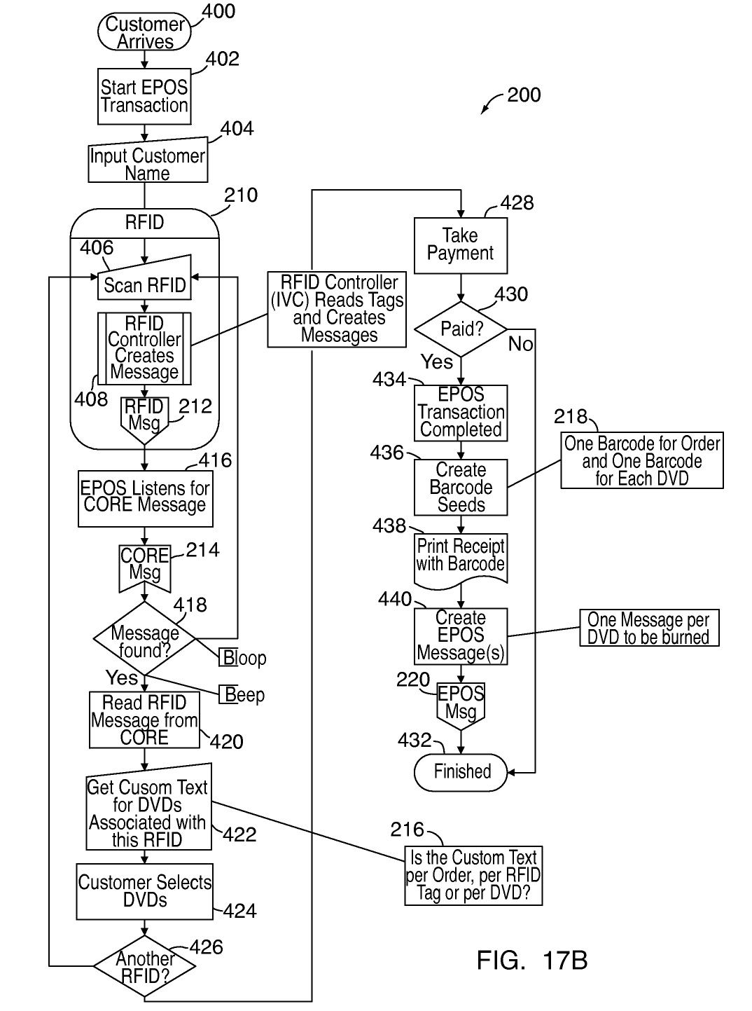

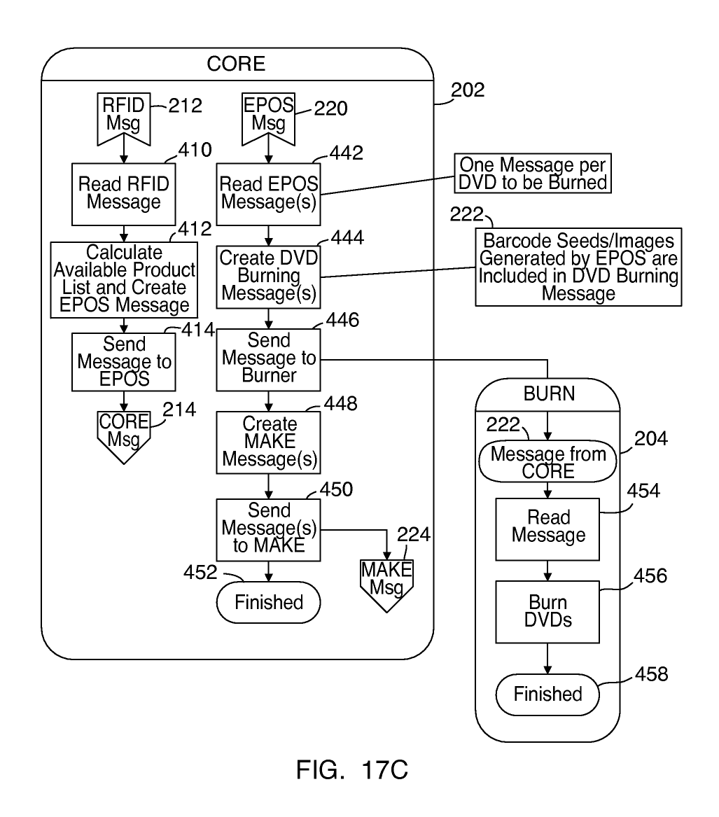

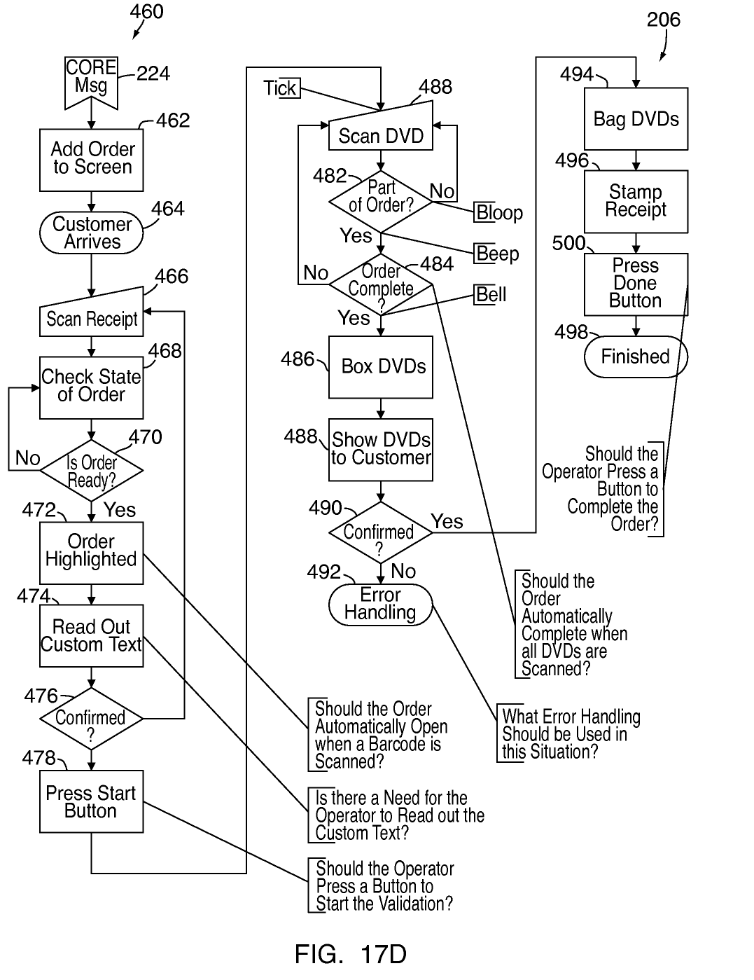

One embodiment of the DVD creation and EPOS sub-system 72 is shown in more detail in FIGS. 17A-17D. As indicated in FIG. 17A, the DVD creation and EPOS sub-system 72 includes an EPOS component or module 200, a core module 202, a burn module 204, and a “make” module 206. Generally speaking, the EPOS module 200 (see FIG. 17B) is configured to process payments, the core module 202 (see FIG. 17C) is for coordinating the various functions of the DVD creation and EPOS sub-system 72, the burn module 204 (see FIG. 17C) interfaces with the DVD burner sub-system 114 (e.g., the DVD burner controller 186), and the make module 206 (see FIG. 17D) carries out a validation process for ensuring that patrons receive the correct DVD's or other video products. For inter-module communications, the modules 200-206 exchange messages in the form of XML files 208. For example, for communications from a source module to a target module, the source module leaves an XML file 208 in a designated drop folder. Each module delivers messages to a particular folder, and there is one folder for each type of message, as well as an archive folder to store processed messages. The XML file contains all the information that the target module needs to process the message. The target module monitors the drop folder for new messages and processes them as required, moving messages to the designated archive folder once they are processed. In this manner, each module operates as a separate entity, decoupled from the core system.

Operation of the modules 200-206 will now be further explained with respect to a typical workflow process. At Step 400 in FIG. 17B, at the end of a visit to a theme park 54, a customer/patron 58 arrives at the EPOS terminal 102 or other designated location for obtaining a personalized DVD or other video product 62. The EPOS transaction commences at Step 402, which may involve the patron interacting with a clerk or other human operator, or with a computer terminal configured for the process, e.g., a touch screen system offering various menu options. At Step 404, the patron's name is optionally entered into the system, for recordkeeping and/or validation purposes or the like. At Step 406, a local, short range RFID reader 210 is used to scan the patron's RFID wristband 74 for obtaining the customer identifier 78. If other encoding means are used, e.g., magnetic strip or bar code, then the customer identifier is obtained using reader means appropriate for the type of encoding means, e.g., bar code reader or magnetic strip reader. At Step 408, the RFID reader 210 generates an RFID message 212, which contains the customer identifier 78 and possibly other information. The RFID message 212 is stored in a folder that is designated for access by the core module 202.

At Step 410 (FIG. 17C), the core module 202 reads the RFID message 212. At Step 412, the core module 202 calculates the available product list (e.g., indicating what video products 62 and/or product options are available to the patron in question) and adds them as a “menu” of available items to the RFID message 212. At Step 414, the core module 202 stores the resultant “core” message 214 in a folder that is designated for access by the EPOS module 200. At Step 416 (FIG. 17B), the EPOS module 200 looks for the core message 214. If no message is found (after a designated short time period), as determined at Step 418, the EPOS module 200 prompts for re-scanning of the patron's RFID wristband, as at Step 406. (If no message is found, this indicates that the core module 202 was unable to generate a message, due to a misread customer identifier or otherwise.) If a message is found, at Step 420 the EPOS module 200 presents a menu of the available items/options for the scanned customer identifier, based on the received core message 214. At Step 422, the operator or patron enters custom user text 216 into the system, which is selected by the patron. This text is used for the DVD validation process. It may also be included in the video product 62, such as for inclusion in the DVD titles. Examples include a family name, or the name of the individual patron. A default may be provided, such as the patron's name. At Step 424, the patron selects the desired DVD products or other video products and/or product options from among the available options. (Possible options include DVD's in various formats and resolutions, videotape, solid-state memory such as USB thumb drives, website-based retrieval, and the like. Alternatively or in addition, video products may be available on a ride-by-ride basis.) At Step 426, the patron is given the option of entering additional customer identifiers into the present order, through RFID scanning or otherwise. For example, it might be the case that more than one family member has an RFID wristband, for creating multiple DVD's. At Step 428, a payment transaction is carried out in a standard manner, such as a cash transaction or processing a credit card or debit card. If payment is not made, as at Step 430, the process ends at Step 432.

Once a customer wristband 74 is successfully scanned for final processing, the wristband is retained by the clerk or other operator for re-use on a different day. If the EPOS module user interface is implemented as an automatic kiosk or other terminal, the customer may be required to insert the wristband into a kiosk receptacle for reading, after which the kiosk retains the wristband.

If the payment transaction is successful, the EPOS transaction is considered complete, as at Step 434. At Step 436, the EPOS module 200 creates various barcode seeds 218. (A barcode “seed” is a code or other information input into a barcode generator for generating a unique barcode. The system stores the barcode seed to generate the barcode, rather than storing an image of the barcode.) Typically, there is one barcode per order and one barcode for each DVD 62. Each DVD product and each order is provided with a unique barcode to be used for validation purposes, as discussed in more detail below. The DVD barcode prevents the clerk or other operator from double scanning a DVD and making a mistake in the order. In addition to the barcode, each DVD is also provided with external, printed text content (e.g., printed on the DVD, a DVD label, or DVD package) for identification purposes, such as the customer-selected custom text 216. Other text may include the name of the theme park 54, a particular ride 60, or the like. At Step 438, the EPOS module 200 prints a receipt for the customer, which contains the order barcode. At Step 440, the module 200 generates one EPOS message 220 per DVD to be burned, which is stored in another folder designated for access by the core module 202. The EPOS message 220 includes the order barcode seed, order number, customer identifier(s), DVD barcode seed, list of what DVD's are to be burned, etc.

At Step 442 (FIG. 17C), the core module 202 reads the EPOS message(s) 220. At Step 444, the core module 202 generates a DVD burning message 222 for each DVD to be burned, which is sent to the burn module 204 at Step 446. The message 222 contains the barcode seed for the DVD in question, as generated at Step 436, in addition to user text 216 and whatever other information is required by the burn module 204 for burning a particular DVD. At Step 448, the core module 202 generates a “make” message 224, which is sent to the make module at Step 450. Typically, the make message 224 includes the same or similar content as the EPOS message 220. For this transaction, the core process is considered complete, as at Step 452.

The burn module 204 handles the burning of DVD's 62. Thus, to summarize, the EPOS module 200 creates a set of file messages instructing what DVD's are to be burned. The core module 202 reads the messages. The core module 202 then creates messages relating to DVD burning, and passes them to the burn module 204. At Step 454, the burn module 204 reads the messages 222, and, as at Step 456, controls system equipment (e.g., the burner controller 186, individual DVD burners, or the like) for burning the DVD's in question. Externally, each DVD includes its designated barcode, user text, additional text, printed graphics, and the like. Digitally stored internal contents, personalized for the customer in question, are as described above. For each particular DVD burning message 222, once a DVD is created, operation of the burn module 204 is considered finished, as at Step 458. The physical DVD 62 is deposited in a receptacle or other designated location for operator or user access, such as a DVD burner out/access tray.

Referring to FIG. 17D, at Step 460, the make module 206 receives the make message 224 from the core module 202. At Step 462, the make module 206 adds the customer order to a screen or other display, based on the make message 224, for purposes of indicating that an order is pending. At Step 464, after a short, designated wait time to account for DVD creation, the customer arrives at a designated collection point, such as the EPOS terminal 102. At Step 466, the clerk or other operator scans or otherwise enters the order barcode on the customer's receipt, which identifies the order in question. At Step 468, the make module 206 checks the status of the order, as identified based on the scanned barcode. If the order is ready, as determined at Step 470, the order is highlighted on the display at Step 472, including display of the customer's custom text 216. At Step 474, the operator reads aloud the customer's custom text 216, for initial validation purposes. If the customer confirms the text content, as at Step 476, the operator starts the DVD validation process at Step 478. (Steps 474 and 476 are optional.)

To validate the DVD's, the operator retrieves the DVD's for the customer's order from the designated receptacle(s). For each DVD, at Step 480 the operator scans the barcode on the DVD. If the DVD is not part of the order, as determined from the barcode at Step 482, the operator may try again at Step 480, or set the DVD aside as not being part of the order. If the DVD is part of the order, at Step 484 the make module 206 determines if the order is complete. If not, the operator continues at Step 480 for scanning the next DVD in the order. If so, the DVD's are boxed at Step 486. At Step 488, the DVD's may be shown to the customer for visual confirmation, based on the custom user text 216 printed on the DVD and/or DVD box. If the DVD's are not confirmed as belonging to the customer, as at Step 490, error handling is carried out at Step 492. This may include starting over at Step 466, accessing the central manager 198, or the like. If the DVD's are visually confirmed, the DVD's are bagged at Step 494, the receipt is optionally stamped or cancelled at Step 496, and the process is considered complete, as at Step 498. Optionally, the operator terminates the process at Step 500 by entering a designated command into the make module.

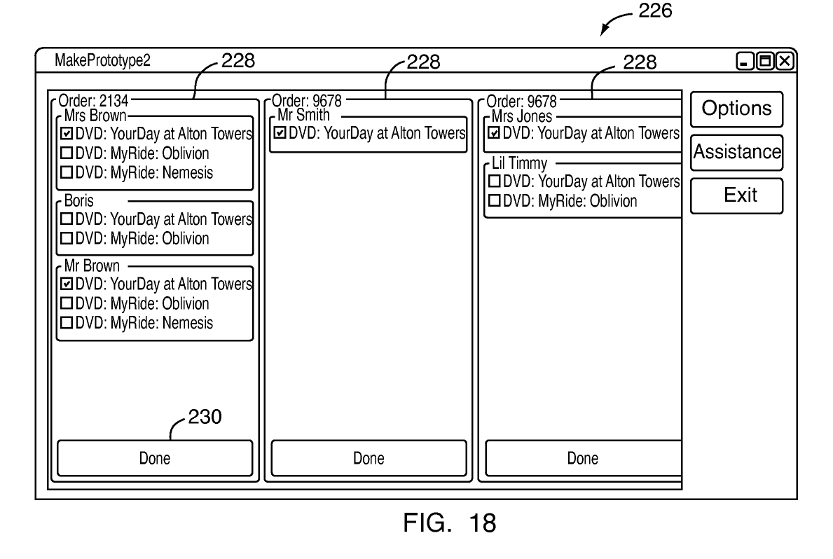

The make module 206 and EPOS module 200 each include a GUI or other user interface, which are displayed on local terminal screens/displays, such as on an EPOS terminal 102. The user interfaces may be configured in a number of different manners. For example, for the make module 206, the module monitors a drop folder for messages 224, and processes the messages to add to a list of orders, as at Step 462. The module maintains an internal list of orders and updates a screen display 226 (see FIG. 18) as the order list changes. The screen display 226 includes a central panel of “order controls” 228, which lists a queue of orders in a row, oldest order on left, newest order on right. Each order control 228 includes an order number, user text, list of DVD's, etc. A “done” button 230 may be displayed for concluding a transaction as at Step 500. An order is removed from the central panel when the “done” button is pressed. The user interfaces may be configured to emit various noises (e.g., “bleep,” “bloop,” “tick,” or “bell”) for different steps of the process, to audibly indicate a success, fail, next, or completed status.

Optionally, the system 50 is provided with a function for displaying the personalized video content or other content to customers prior to the payment transaction at Step 428. For example, after scanning the customer's RFID wristband as at Step 406, the EPOS module 200 could be configured to access the personalized video clips 56 associated with the scanned customer identifier. The personalized video clips 56 would then be shown to the customer on a display, in whole or in part. (For example, the system 50 could show one of the clips in its entirety, perhaps in conjunction with a subset of the stock footage, or perhaps a trailer-like montage of portions of the personalized clips.) The displayed content would allow the customer to assess the content, thereby motivating or encouraging the customer to purchase a DVD.

For any system errors, e.g., if a DVD is missing, faulty, or damaged, the customer is dealt with as an exception. (See Step 492.) Since retail unit lanes may be very restricted in terms of space and time, a manager or customer relations person will typically take the customer to another area to handle the problem.

As should be appreciated, at the retail level (e.g., EPOS and make modules), the system 50 may be configured in any number of different manners. As such, the functionality described above is merely an illustrative embodiment of the present invention.

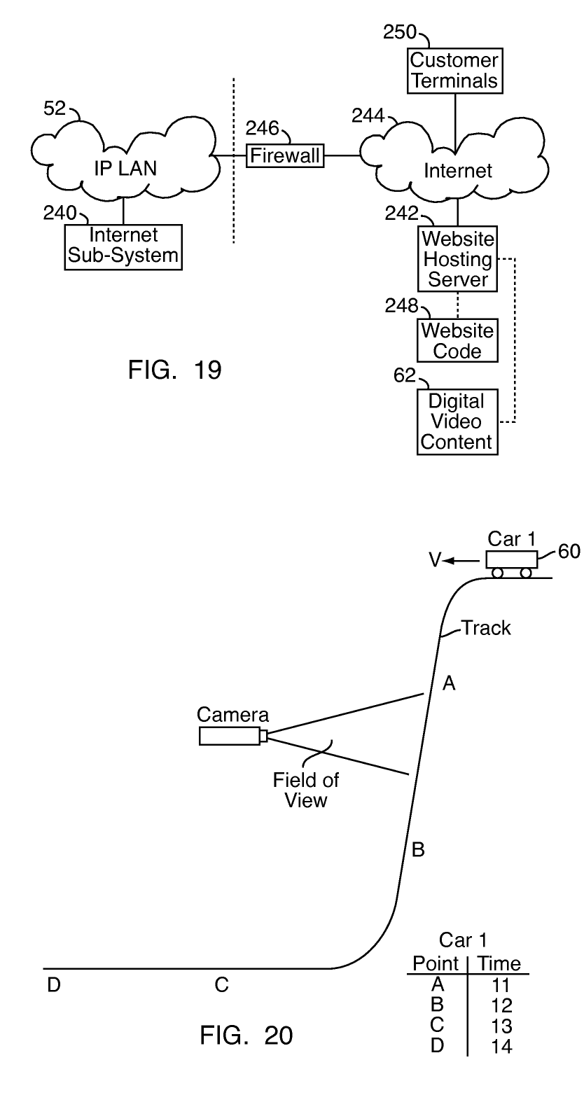

The system 50 may include website functionality for delivering video products 62 to theme park patrons. As shown in FIG. 19, for example, the system 50 could include an Internet sub-system 240 interfaced with the IP LAN 52. The Internet sub-system 240 would act as the interface between the remainder of the system 50 and an external website hosting server 242, e.g., for transferring data from the DVD creation and POS sub-system 72 to the server 242. The Internet sub-system 240 would connect to the Internet 244 through a firewall 246 or the like. The server 242 would contain html or similar code for implementing a customer-accessible website 248. Customers would access the website 248 from their respective home terminals or other computer terminals 250. The hosting server 242 would store DVD or other digital product data 62, including stock video clips, personalized video clips, and the like, in one or more formats such as .MOV and .AVI. Customers would access the website for obtaining copies of the digitally stored video clips, by file download or otherwise. Other possibilities include remote video display of streaming media and Flash-based media. Typically, the website 248 would include appropriate security and authorization safeguards for limiting access and content retrieval to authorized individuals, based on receipt number, customer number, date of visit, etc. Payment functionality could also be included.

Instead of using RFID wristbands, bar-encoded cards, or other encoded identification means, the system 50 may utilize biometric or biogenetic identification means to identify patrons in a theme park. One example is facial recognition.

Although the system 50 has been illustrated as using photoelectric cells, many other types of sensors could be used instead, such as magnetic sensors and mechanical switches, without departing from the spirit and scope of the invention.

In another embodiment, the system 50 is configured for grouping customer identifiers together for producing the final video product 62. Here, more than one family member (or other grouping of people) would be provided with an RFID wristband or other identification means. Each would have a different customer number, but the customer numbers would be linked together in the database 101. Upon returning the wristbands at the end of the day, the final video product 62 would be produced to include personalized video clips associated with both customer numbers. Various algorithms could be implemented for deciding which personalized video clips to include, e.g., if both customer numbers went on the same ride but were associated with different ride cycles, both video clips would be included (or perhaps a montage of both), but if both customer numbers were associated with the same ride cycle, only one set of video clips for that ride cycle would be included.

In another embodiment, family or other group members are provided with multiple RFID wristbands, but all of the wristbands have the same customer identifier. The system works similarly to as described above, but with processing algorithms in place for handling (i) multiple instances of the customer number being detected on the same ride cycle and (ii) multiple instances of the customer number going on the same ride at different times.

As should be appreciated, the menu and content structure of the DVD or other video product may be configured in a number of different ways to accommodate different implementations of the system. For example, “leftover” personalized video content, such as video clips of a patron going on the same ride multiple times, could be relegated to an “extras” portion of the DVD apart from the main program, or to an alternative track that is accessed by activating an “alternate camera angle” feature of the DVD player system.

In another embodiment, patrons are able to pre-select or post-select which of the personalized video clips (and/or associated stock video clips) are to be included on the DVD product 62, on a ride-by-ride basis or otherwise. For example, especially in the context of an automatic “check out” kiosk, customers would be presented with a menu listing the rides that they were detected as having gone on, with an option to include the video associated with the ride cycles in question or not. Customers could also be provided with options for custom editing, adding titles and graphics, and the like.

As indicated above, the system 50 contemplates not only the inclusion of personalized video content, but also “still” digital pictures/photos. For example, one of the personalized capture areas 82 could include a station where customers are able to initiate the capture of a group photo. Customers would stand in a designated area in the field of view of the camera, and, when ready, actuate a manually activated switch or button. After a short wait time (e.g., 1-3 seconds) to allow for final repositioning, possibly in conjunction with a countdown indicator, the system would detect the customer identifier and activate a locally positioned digital camera or other still capture unit, including activation of a camera flash if needed based on light exposure. Captured content would be associated with the customer number as described above.

FIG. 20 further illustrates, in a simplified manner, how use of the continuously generated raw clips 92a-92c allows for camera sensor repositioning, for situations where it may not be practicable to position the camera sensors near the cameras. As indicated, a ride vehicle 60 travels along a track at a variable velocity “v”. Camera sensors could be placed at points A and B. (Here, each sensor A and B detects when the first ride vehicle car goes past the sensor. Sensor B is positioned past the camera field of view so that when it is tripped by the first ride vehicle car, the last ride vehicle car has just left the field of view. As such, positioning of sensor B is based on the length of the ride vehicle. Alternatively, sensors may be managed to detect when the first car enters the field of view and when the last car leaves the field of view.) If that is not possible, however, sensors may instead be placed only at points C and/or D. The ride vehicle enters the camera field of view at time “t1,” and leaves at time “t2.” This time period is the time period of interest for the designated video clip. However, the sensors are not tripped until times “t3” and “t4.” To identify the designated clip, the system looks back from, e.g., time t3 by a “Δt” value, where Δt is the time it takes for the first ride vehicle to travel from point A to point C. This may be determined empirically, or by calculating the distance between A and C divided by the ride vehicle velocity. At may be considered to be a static value, or a value that is variable only slightly, i.e., it may be assumed that the ride always takes the same time to travel between points A and C. Alternatively, velocity may be measured using sensors, or a correction factor may be included based on the total number of patrons in the ride vehicle (recognizing that a variable mass may affect the velocity profile).

In another embodiment, for each ride or other personalized capture area, different sets of stock video content are available for inclusion in the video product based on factors such as time of day, light conditions, and/or weather conditions. Thus, for example, for each ride, there may be a set of stock video content for the ride at night, and for the ride at day. Depending on time of day and/or ambient light readings when personalized video content is captured, the system chooses either the day or night stock footage for including the final DVD or other video product.

To reiterate, with respect to the customer interface, all or a portion of the system 50 may be automated. For example, in one embodiment a customer accesses an automated EPOS kiosk to obtain an RFID wristband at the start of the day. The kiosk includes a touch screen for the customer to enter personal information, such as payment information and name and address. The wristband is provided through a vending-type mechanism, which only dispenses wristbands to authorized individuals, e.g., those who have provided valid credit card information. At the end of the day, the customer returns the wristband to the kiosk, which prompts the customer for payment verification. Subsequently, the customer is given a wait time and provided with a receipt, and is instructed to retrieve the video product(s) at a designated location, such as a retail store. After the designated wait time, the customer retrieves the video product from the designated location, where an operator or clerk verifies the video product in the manner described above. Alternatively, the kiosk may dispense the video product on the spot.

In another embodiment, the system is provided with functionality for a customer to provide his or her own digital storage medium, for the video product to be stored thereon. In particular, many portable electronic devices (cameras, phones, video cameras, portable computers, PDA's, USB thumb drives, etc.) now have large amounts of mass storage available. The system could be provided with an electromechanical interface (e.g., USB port) and/or wireless interface (e.g., Bluetooth) for the system to store the completed video product on the customer's portable electronics device.

For interfacing the camera and/or ride sensors or other sensors with the IVC units, an Ethernet/TCP-IP to I/O port/serial interface unit may be utilized, such as the W&T Interfaces “Web-IO, 12× digital with RS-232-Com-server functionality” unit, product number 57631. Such an interface facilitates advanced traffic control between the sensors and IVC unit, allowing for more control over what messages are sent to the IVC for triggering. Device management and diagnostics are also improved.

Although the system 50 has been primarily illustrated as utilizing wristbands for the housing the RFID devices, other portable enclosure means could be used instead, such as badges, buttons, rings, necklaces, other types of bracelets, broaches, buckles, etc.

Cameras may be positioned not only around a ride or other personalized capture area, but also on the ride vehicles themselves. This includes the possibility of one on-ride camera that captures all the patrons on the ride, or cameras built in or otherwise located on each ride car, which are configured to capture video content only of the patrons in that one ride car. For this configuration, the car would also be equipped with a local RFID detection device, for associating the patrons in the ride car with the camera(s) for the ride car. Alternatively, RFID detectors could be located in turnstiles, railings, lanes, or other queue- or flow-control means that divide patrons into queues for each ride car, e.g., the patron has to pass through a particular turnstile, etc. to enter a particular ride car. For on-ride cameras, data may be transmitted wirelessly when it is generated, directly from a transceiver unit interfaced with the camera or cameras, or it may be stored in a PVR or other storage device on the ride itself. Data could be retrieved from the on-board PVR unit using a number of different means. One example is wireless, wherein the PVR unit would initiate transmission of raw video clips each time they are generated, or wait until the ride arrived at a station to transmit the data in a burst or batch mode over a high data rate local wireless connection. Alternatively, a data cable could be attached to the ride vehicle for data download when the ride is stopped at the station to exchange passengers.

Although the system has been illustrated as using “always-on” cameras, this does not preclude the possibility that some of the cameras could be activated using a trigger means, such that video content was only generated when the camera was triggered. For example, for still images, it may be more appropriate to use a digital still-type camera with trigger means, instead of pulling individual frames out of an always-on video camera.

Because the system 50 involves capturing video content for providing to specific individuals, it is desirable to ensure that each patron is uniquely and securely identified within the system. For doing so, the RFID devices 74 may each be outfitted with a unique or near-unique serial number, which are also used as part of the process for associating video content with a particular patron, either at the theme park or at a later date, such as accessing content through the Internet.

To explain further, the system 50 may be configured to encode a unique serial number that is stored on a 96-bit tag or other RFID device 76 and printed on a visible label, for use on RFID wristbands 74 in theme parks 54. The unique serial number may be a customer identifier 78, or it may be associated with a customer identifier 78. The visible label is used to identify the wristband if the RFID device 76 is somehow unreadable. The number to be stored on the tag will be referred to as a “UID” hereinafter, and the printed code will be referred to as a “PCODE” hereinafter.

The general principals for encoding the wristbands 74 are as follows. First, existing standards should be followed without subscription. This will prevent other tags from contaminating this application, prevent the theme park wrist bands from contaminating other applications, and mean there are no subscription costs. Second, the system ensures that the UID's are always unique, at least within a very large production range. In particular, the RFID devices carry a logical encoding mechanism that ensures uniqueness across the whole range. Third, a short, clear coding mechanism is used for the PCODE's. For this, characters are limited to unambiguous number and letters. Additionally, the code should be as short as possible to allow for the use of a large font in the space available, and to minimize the number of characters that need to be typed in by users. Fourth, a measure of redundancy is built in such that not all UID's and PCODE's are valid. This will prevent random PCODE's being entered, thereby addressing privacy concerns. Fifth, it is ensured that the UID's and PCODE's have no logical sequence. This prevents anyone from predicting the next valid code based upon his own code. Again, this demonstrates due diligence to privacy, by ensuring that nobody can “work out” what someone else's number will be. Finally, it is ensured that there are at least 1 billion different valid PCODE's.

For encoding the PCODE's, each PCODE will be made up of 8 characters printed in a row: NNNNNNNN. Each character N is taken from the set: “3, 4, 6, 7, 9, A, E, F, G, H, J, K, L, M, N, P, R, T, V, W, X, Y, Z.” (This represents 23 different symbols with ambiguous symbols removed). Both upper and lower case letters will be accepted and the number “2” should be accepted as a “Z”. Examples: (i) E3XK73JF; (ii) 4PTA6HLL.

The PCODE is converted to a number by treating it as a base-23 number. Each symbol is given a value according to the table in FIG. 21. The algorithm is as follows:

```
ulong ConvertPCodeToInt(PCode : string)
{
    ulong result = 0;
    for (int i = 0; i < 7; i++)
    {
        result = (23 * result) + (ulong)CharacterValue(PCode[i]);
    }
}
```

Here, “Character Value” converts a character to the value represented in the table in FIG. 21. The example “E3XK73JF” therefore has a numerical value of 20,560,794,531.

For UID encoding, EPC coding for “GID-96” is used. This is defined as shown in the table in FIG. 22. In this table, the “Header” field defines the UID as a GID-96 or “General Identifier,” as opposed to other more specific identifier types. Tags that are used in other specific applications (including some sensitive ones such as Dept. of Defense) carry a different value here. The “General Manager Numberr” is normally administered by EPCGlobal, but at a cost. EPCGlobal is currently issuing numbers in the range 95,100,000 to 95,199,999. Here, a number is used that is outside of this range, which will remain fixed for all tag encodings. The number is: “197,532,988.” “Object Class” is the field used to denote a particular application. Theme park wristbands will have the following numbers reserved: 37031-37038. In the “Serial Number” field, 31 bits of the 36 will be used to store a number calculated from an incrementing number at time of production. The remaining 5 will be used as check digits.

To demonstrate diligence in the protection of individual wristbands and the application from misuse by individuals typing in random or consecutive codes in to the website 248, 31 out of 32 PCODE's entered will not be valid, when generated as described above. Despite this, the printed code is only 8 characters, thus reducing errors and allowing the use of a large font size for higher visibility. Additionally, there will be 2,147,483,648 valid physical wristbands (PCODE's) before any duplication of the same printed number. If more than this number of bands is produced, then it is assumed that it will be safe to start to re-use PCODE's. In that case, the system will move to the next value in the “Object Class” field for encoding UID's. The serial number actually encoded will be derived from an incrementing number by using a reversible scramble function. The check-digits will be calculated from the scrambled number. This makes the numbers sequence agnostic. Therefore, a total of 17,179,869,184 possible UID's have been allocated for use as theme park wristbands.

With reference to FIG. 23, the lens control system 146 may be implemented as a camera agnostic lens control (“CALC”) system 600. The CALC system 600 includes a multi-axis photometer head (“MAPH”) 602, a lens controller module (“LCM”) 604, plural lens motors 606, plural lens gears 608, and a mounting bracket system 610.

The multi-axis photometer head 602 includes a 25-50 mm diameter “dome” that fits through a circular hole in the top of the camera weatherproof housing 140. The dome and housing are interfaced using a waterproof seal, in the form of either an o-ring or a neoprene washer. A threaded nut tightens the MAPH onto the housing. A short cable 612 (<1 m) exits the base of MAPH (inside the camera housing) and is terminated by a small multi-pin plug. Inside the MAPH are at least five daylight/infrared sensors 614. The signal from the sensors is converted in the MAPH to digital data and sent to the LCM 604 via the cable 612. Four of the sensors are arranged in cardinal directions, and a fifth sensor assesses general illumination levels. The design of the MAPH enables a determination of not only the average light level, but also an estimation of the direction of illumination, which may be important for the correct automatic exposure of backlit vs. front-lit scenes (e.g., sun behind a ride vehicle vs. sun from the front vs. general soft light).

The lens controller module (LCM) 604 has two main functions. The first is to facilitate the remote zooming and focusing of the camera 86 via an external serial host 616, and to ensure that this position is maintained. The second is to interpret the photometric data from the MAPH and estimate the correct lens iris setting. Communication with the serial host allows for remote override, setting, and remapping. The LCM 604 also drives the lens motors 606, each of which is a small servomotor, e.g., a polyphase stepper motor. The LCM 604 sends/receives RS232 data (9600,8N1) and require a 12V (2 amps max) supply. The LCM connects to and powers the MAPH directly.

Three lens motors 606 are mounted onto the mounting bracket 610, one for each of the lens functions, namely, focus, iris, and zoom. Each lens motor 606 has a small gear attached to its output shaft that connects to one of the lens gears 608. As noted above, each lens motor 606 may comprise a small poly-phase stepper motor mounted onto an aluminum machine plate that can be slid up and down the mounting bracket 610. Each lens motor 606 has a short cable (<0.5 m with connector) for connection to the lens control module 604.

The lens gears 608 will be custom made for each type of lens, e.g., for a Pentax 31204 lens (which is one type of lens suitable for use with the video cameras 86) the gear will have an external diameter of approximately 70 mm and an internal bore of around 51.2 mm. The gears may be split so that they can be secured to the relevant lens ring. Different lenses may require different gears.

The mounting bracket system 610 comprises a machined block that has two or more forward facing, 10-15 mm diameter bars 618 protruding there from. These bars are for mounting the lens motors 606. In most situations, the camera is mounted to the mounting bracket so as to maintain a solid connection between the camera, the lens, and the lens motors. The mounting bracket will typically be designed for a particular camera and lens type, and/or it may be provided with a degree of adjustment functionality for possible use with other camera/lens combinations.

Generally speaking, the lens control module 604 will be designed so that different look-up-tables maybe uploaded across the host network 52. It may also be possible to write a boot-loader so that the entire firmware of the LCM 604 may be remotely updated. This allows for a certain amount of development after the devices have been installed. The LCM will be able to report back current lighting levels over the serial host network, which may allow the host system to record lighting levels against video timecode, to allow for an in-depth analysis of how the system works in a live environment. The remote measurement of ambient light levels, time of day, and quality and direction of light may allow for sophisticated color/gamma correction mechanisms.

Additional features of the various modules shown in FIG. 15 are summarized in the following tables.

| Module Name | Ride Configuration | |
|---|---|---|
| Description | All the rides in the theme park should be configured well in advance. | |
| | The ride table includes the following fields: | |
| | 1. | RideKey (PK) |
| | 2. | RideID (Integer) |
| | 3. | RideName (Varchar(8)) |
| | 4. | RideDescription (Varchar[150]) |
| | 5. | IsRide (Chr[1]) - Signifies whether this is a regular Ride or a |
| | | Choke (Pinch) Point. |
| | 6. | WaitTime (Numeric) - The value is in milliseconds. Signifies |
| | | the WaitTime for the DVD MP (DVD multiplexer - see below) |
| | | before it starts processing DVD Images. This helps the DVD |
| | | MP to determine how long to wait before preparing DVD |
| | | Image even if all the MPEGs are not available for the Ride (of |
| | | course, it can prepare the Image only if all the MPEGs for the |
| | | required Cameras are available and it can ignore any missing |
| | | MPEGs for “not required” cameras). |
| | 7. | Suspended (Chr[1]) - signifies that the Ride has been |
| | | suspended for some reason. It could be because of an Accident |
| | | or any other reason. The DVDMP does not produce the DVD |
| | | Image if it finds that the Ride is in a suspended state. The |
| | | operator would be able to mark the suspension through Web |
| | | CM. |

| Module Name | Ride Manager (“RM”) 170 | |
|---|---|---|
| Description | The Ride Manager interfaces with the IVC RFID application or | |
| | otherwise. The RM polls a predefined folder, retrieve XML files | |
| | (deposited by IVC software), and update the master database. RM has | |
| | no interface with the hardware. MDLC interfaces with its IVC module, | |
| | consolidates data and deposits one XML file for each ride cycle. There | |
| | will be one RM per node, since there is one MDLC per node. | |
| Functionality | 1. | RM polls a pre-configured network folder and retrieves XML |
| | | files as soon as they are available. |
| | 2. | The XML file contains the Ride Name, all the RFID's in the |
| | | Ride Cycle (e.g., RFID's == detected customer identifiers), a |
| | | Sequence ID, and possibly other fields. |
| | 3. | RM generates the next Ride Cycle Number (RCID) for the |
| | | given ride and inserts all the XML data into the database. The |
| | | inserted data would have “Master → Detail” relationship |
| | | between RCID and RFID's. |

| | |
|---|---|
| a. | Master Table would contain a RMKey(PK), |
| | LocationID = RideKey, RCID (generated) and Status = 0 |
| | fields. |
| b. | Detail Table would contain RMKey(FK), |
| | AssetID = RFID, ActivityType, ReaderID, SequenceID, |
| | DateAndTime. |
| c. | The Data Type and Size should match the data in the |
| | sample XML file in .PDF. |

| | 4. | For each Ride Cycle, RM should create a stack of rows in |
|---|---|---|
| | | “SensorTriggers” Table with RMKey, CameraKey and Status = 0 |
| | | fields. |
| Assumptions | 1. | Each ride in the theme park will have predefined unique Ride |
| | | ID and a short “Ride Name”. |
| | 2. | The above Ride Name would be used to configure IVC so that |
| | | it inserts the same data into the XML file. |
| | 3. | MDLC is totally responsible for aggregating the data received |
| | | by IVC's and generating appropriate XML data. |
| Validations | 1. | System raises an exception if XML data is not in a desired |
| | | format. |
| | 2. | RFID (AssetID) should not repeat in a single XML file. |
| Alternative Path | RM should take an alternative path and accomplish the following if a | |
| | given Ride is a Choke Point (IsRide = False): | |
| | 1. | Insert a Row into VSM table that enables VCC to prepare an |
| | | appropriate AVI clip. |

| Module Name | Video Sensor Manager (“VSM”) 174 | |
|---|---|---|
| Description | The video sensor manager interfaces with the camera sensors 94. There | |
| | will be one VSM per ride. | |
| | The VSM consumes a public interface “YDSensorCluster” which in turn | |
| | raises an event each time a camera sensor is triggered, and passes the IP | |
| | address and trigger time back to VSM. VSM should be able to | |
| | determine which IP address maps to which camera. | |
| | The VSM is also responsible for managing configuration settings for | |
| | each camera, such as wait time, duration of the clip, and calculate start | |
| | clip and end clip time based on trigger time. | |
| Functionality | 1. | A unique IP address (“IPAddress”) is assigned to each camera |
| | | sensor and the same is stored in the respective row in the Camera |
| | | Table. |
| | 2. | Camera Table also associates each camera with a ride. |
| | 3. | Each VSM should be configured for a specific ride. |
| | 4. | Each VSM service instantiates YDSensorCluster class and calls a |
| | | method called “AddSensorArray” and provides an Array (Objects) |
| | | of IPAddress and other data as an Array parameter. |
| | 5. | YDSensorCluster class raises “Detected” Event each time a Camera |
| | | Sensor is triggered and provides IPAddress, TimeStamp and |
| | | Confirmed parameters back to VSM. |
| | 6. | VSM should determine the camera associated with each IPAddress. |
| | 7. | VSM should insert data into VSM table, such as Camera Key, |
| | | Sensor Trigger Time, Start clip time and end clip time. The data |
| | | may have to be computed using an algorithm and the data from |
| | | Camera Configuration table. |
| | 8. | Update “SensorTriggers” table and mark Status = 1 if |
| | | Confirmed = True or Status = 2 for Confirmed = False for the |
| | | respective RMKey and CameraKey indicating that this Camera |
| | | Sensor has been triggered. |
| | 9. | Item 7 & 8 should be enclosed in a transaction so that they both |
| | | succeed or fail together. |
| Assumptions | 1. | Start Clip Time and End Clip Time are calculated based on |
| | | configuration setting such as Latency value, Duration of the Video |
| | | and Sensor Trigger Time. |
| Validations | 1. | Should raise an exception if no cameras are found for the given |
| | | ride. |
| | 2. | The IP address returned by YDSensorCluster class must be one of |
| | | those initially passed by VSM. |
| | 3. | VSM should raise an exception if there is no corresponding |
| | | CameraID found in SensorTriggers table with status = 0. |

| Module Name | PVR Interface (“PVR”) 88 | |
|---|---|---|
| Description | PVR captures the camera output video stream, and splits the stream | |
| | into AVI files of xx seconds each. The files will be placed in a specific | |
| | folder on each PVR and each PVR will be connected to only one | |
| | camera. The files will be named with “RideID + “_” + CameraID + “_” + | |
| | TimeStamp.AVI”. The naming convention of these files would make | |
| | other interfaces to identify the files using start time and end time. | |
| Functionality | 1. | Configure Camera Table with FrameRate and other fields. |
| | 2. | Configure the PVR with Camera Key, PVR Clip Duration. |
| | 3. | PVR would use FrameRate from Camera Table to set the |
| | | internal property. |
| | 4. | Retrieve the path from Camera Table to store files. The |
| | | configuration of the folder path can reside either in Camera |
| | | Table (or in .config file of each PVR until DB oriented |
| | | configuration is implemented). |
| | 5. | The Folder should be created if doesn't exist. |
| | 6. | PVR splits Video streams into AVI files of specified duration. |
| | 7. | The AVI files are stored in a pre defined Shared Folder (Local). |
| Assumptions | 1. | VCC can determine which PVR to call based on camera |
| | | configuration in the database. |
| | 2. | The PVR can emit AVI files in 10-second clips. However, there |
| | | is a loss of few frames each time a new file is created. Hence, it |
| | | may be necessary to increase the duration. The options are 15, |
| | | 20 or 30 seconds. |
| | 3. | VCC knows the actual start and end times of the designated |
| | | clip(s) from VSM table and can prepare the file names to |
| | | process (one or more files). |
| Validations | 1. | Should raise an exception if no camera is connected to PVR |
| | | interface. |
| | 2. | Should raise an exception if there is a problem in either |
| | | generating file names or storing files on the disk. |
| | 3. | Folder should be created if doesn't already exist. |

| Module Name | Video Clip Creator (“VCC”) 100 | |
|---|---|---|
| Description | The key functionality of VCC is to create a single video clip per camera | |
| | per ride cycle. There is one VCC per ride. | |
| | VCC fetches AVI files matching specified criteria at fixed intervals from | |
| | each PVR, and creates an appropriate video clip for each camera/PVR | |
| | for each ride cycle based on various parameters. | |
| Functionality | 1. | VCC periodically polls the database to determine the video |
| | | clips to be retrieved from each PVR of a given ride after |
| | | considering the wait time. |
| | 2. | Then, the VCC can request the concerned PVR for the files of a |
| | | given time frame. PVR should just pass the file list for VCC to |
| | | retrieve the files through another method call. |
| | 3. | Upon receiving the above said files, the VCC needs to use |
| | | LEADTOOLS to slice and combine the video clips in order to |
| | | prepare a single AVI video clip for the given ride cycle. |
| | 4. | VCC builds up a single clip (e.g., AVI format) and updates the |
| | | database. |
| | 5. | Name the Output file should be built using StartClip and |
| | | EndClipTime in VSM Table. For ex. “RideID + “_” + CameraID |
| | | + “_” + Time StartClip_EndClipTime .AVI”. |

| | |
|---|---|
| Assumptions | Conversion of video clip from AVI to MPEG2 is done in effects |
| | processor. |

| Module Name | Video Clip Store (“VCS”) 176 | |
|---|---|---|
| Description | The video clip store comprises one or more high-end storage devices. | |
| | They are configured to work on given number of rides. They retrieve | |
| | the AVI files from different VCC's and store the files in the storage | |
| | system. | |
| | There will be one or more per theme park. | |
| Functionality | 1. | Polls VCC table for a list of AVI files to be copied. |
| | 2. | Fetches the AVI files and associated data from VCC's. |
| | 3. | Stores the files in pre defined storage location. |
| | 4. | Makes an entry in the VCS table. |
| | 5. | Updates the Status in VCC table. |

| Module Name | Effects Processor (“EP”) 178 | |
|---|---|---|
| Description | The effects processor is meant for processing the AVI files produced by | |
| | VCC (one file per camera, ride ID, and ride cycle number). The | |
| | processing involves applying brightness, contrast, and color balance on | |
| | each clip. The effects are pre-customized manually using | |
| | LEADTOOLS ® and the data is stored in a centralized location on the | |
| | file system for further reuse. | |
| | The effects processor applies effects and converts the file into MPEG2 | |
| | file format before storing the same in the video archive and DVD | |
| | format store. | |
| | There is one effects processor per ride. | |
| Functionality | 1. | A single “default effects” file is created using the Windows ® |
| | | central manager (see below), which defines the video format |
| | | for the theme park, such as PAL or NTSC. |
| | 2. | A “custom effects” file is created for each camera in the theme |
| | | park. |
| | 3. | EP is configured with the file path for the “default effects” file. |
| | | Custom effects are configured in the camera table. |
| | 4. | EP can poll the database to determine the files are ready in VCS |
| | | for processing, based on the status field in the DB for each file. |
| | 5. | EP can retrieve the clip location on the video clip store based |
| | | on which ride it is configured for. |
| | 6. | VCS table contains the camera ID for each AVI that would help |
| | | EP to apply the correct effects for the clip. |
| | 7. | The “custom effects” file would enough information for EP to |
| | | apply “effects” on the clip. |
| | 8. | The EP fetches the clip from the video clip store, applies the |
| | | specified effects on the clip, and converts the same to MPEG2 |
| | | file format. |
| | 9. | The processed clip is sent to predefined locations on video |
| | | archive and DVD format store, and the database is updated |
| | | with the new locations and also the status. |
| | 10. | EP increments the status in the ride manager table soon after |
| | | processing the AVI for each camera of a given ride cycle. For |
| | | example, the status would be 5 if ride “X” has 5 cameras and all |
| | | the clips were processed for a given ride cycle number. |

| Module Name | DVD Format Store (“DVD FS”) 180 | |
|---|---|---|
| Description | DVD format store acts as a repository for the MPEG2 files created by | |
| | the effects processor, as well as for VOB files created by DVD | |
| | multiplexer. | |
| | There are one or more DVD format stores per theme park. | |
| Functionality | 1. | EP's store MPEG files in a predefined location on DVD FS. |
| | 2. | DVD multiplexers retrieve the above MPEG files, and store the |
| | | multiplexed files into another predefined location. |
| | 3. | DVDFS table is updated every time a new MPEG file is added. |

| Module Name | DVD Burner Controller (“DVD BC”) 186 | |
|---|---|---|
| Description | The DVD BC builds various .JRQ files required by the DVD burning | |
| | software (provided by the vendor of DVD burner hardware). | |
| | Therefore, the main functionality of this module is to visit the database | |
| | periodically, pick the customer identifier with respect to most recent | |
| | sale, and prepare the .JRQ files required to burn the DVD for that sale. | |
| Functionality | 1. | Poll a predefined folder, retrieve a new XML file (dropped by |
| | | the POS system 72) and update the POS table in the master |
| | | database. |
| | 2. | Look up the POS table and retrieve the customer identifier of |
| | | the new sale. |
| | 3. | Lookup DVD MP table and find all the multiplexed VOB files |
| | | for the customer identifier in question. |
| | 4. | Prepare a set of .JRQ files that will be required by the DVD |
| | | burning software and deposit the files in a predefined folder. |

| Module Name | DVD Multiplexer (“DVD MP” or “MP”) 182 |
|---|---|
| Description | Multiplexing is the process of building a project in an authoring program so |
| | that it can be burned to DVD and read by a standard DVD player. Audio and |
| | video files are converted to an MPEG-2 stream, which is converted to a DVD |
| | image output for burning to a DVD. |
| | The DVD image output includes .VOB and .IFO files. |
| | There are one or more DVD multiplexers per theme park. |
| Functionality | Three distinct steps are required during multiplexing life cycle. |
| | Concatenate stock footages and designated/personalized video clips |
| | according to a predefined sequence for each ride. |
| | Combine video and audio streams and create an MPEG-2 program stream. |
| | Convert the above into a DVD image to obtain .VOB, .IFO and .BUP files. |
| | MP periodically polls the database to find completed ride cycles based on Ride |
| | → WaitTime, and starts processing. |
| | MP validates whether the EP has finished processing all the AVI's. This can be |
| | done by looking up ride manager status (RM Status). |
| | EP can still continue even if the status is < number of cameras, but all the |
| | MPEGs for the “Required” cameras are available. |
| | If RM Status = No. of cameras then, EP shall validate whether the MPEG files |
| | (for all the “Required” cameras) are indeed available at the designated |
| | locations. |
| | Raise an exception and abort the process if the criteria in 3.1 or 3.2 is not met. |
| | Retrieves all the MPEG files from DVD FS for a given ride cycle. |
| | Concatenate the MPEG files into single MPEG stream including the stock |
| | footages in an appropriate sequence based on the configuration available in the |
| | database. |
| | Multiplex the above MPEG file along with audio stream and generate MPEG-2 |
| | program stream file for each ride cycle. |
| | Create a DVD image for each MPEG file created in the previous step. The |
| | output would consist of .VOB and .IFO files. |
| | Update the database with the folder path for the DVD image. |
| | The DVD burner controller can eventually compile the various .VOB files |
| | along with other standard .VOB files in order to burn the DVD. |
| Assumptions | The sequence to concatenate stock footages and personalized video clips is |
| And | predefined for each ride. The program stream after step 1.2 above is stored in a |
| Validations | temporary location. Validations: Check whether the given ride is in a |
| | suspended state by looking up Ride →Suspended = “Y”. Do not prepare the |
| | DVD image for suspended rides. |

| Module Name | Central Manager (“CM”) 198 | |
|---|---|---|
| Description | The central manager provides various GUI elements that facilitate the | |
| | administrative capabilities required for managing the application life cycle. | |
| | Provided as a Windows ®-based and/or web-based application. | |
| Functionality | 1. | Windows ® CM provides: |

| | |
|---|---|
| 1.1. | GUI for setting up LEADTOOLS-related configuration such as filter |
| | selections, multiplexing options, etc. |
| 1.2. | GUI for service controller that enables features required to control |
| | Windows services running on computer terminals in a network. |

| | |
|---|---|
| 2. | Web-based CM provides: |

| | |
|---|---|
| 2.1. | GUIs required to configure the various modules with folder path, timer |
| | interval, multiplexing sequence, and other such parameters. |
| 2.2. | Configuration GUIs are required for PVR, RM, VSM, VCC, VCS, DVD |
| | MP, Multiplexing Sequence, DVD BC, Camera, Ride. |

| | |
|---|---|
| Database | Multiple tables are used to store the data. |

Since certain changes may be made in the above-described system for capturing and managing personalized video images over an IP-based control and data local area network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A method of creating a personalized video product, said method comprising the steps of:
for each of a plurality of cameras distributed about a geographic area, substantially continuously recording a video output of the camera into digital storage, during a designated range of hours of operation;
for each of the recorded video outputs, associating at least one clip portion of the recorded video output with one or more customer identifiers, said customer identifiers being determined from RFID devices carried by customers in the geographic area; and
for each of the customer identifiers, compiling the video clips associated with the customer identifier into a video product, said video clips being interspersed in the video product with a plurality of stock video clips relating to the geographic area.

2. The method of claim 1, wherein:
the substantially continuously recorded video output of each camera is digitally stored as a plurality of near contiguous raw video clips, said raw video clips including a first set of non-content video clips lacking video content of customers and a second set of designated video clips containing video content of customers; and
the method further comprises identifying the designated video clips from among the plurality of raw video clips for associating with customer identifiers.

3. The method of claim 2, wherein:
for each camera, the raw video clips are stored locally to the camera in a digital video recorder unit, said unit being designated for sole use with the camera.

4. The method of claim 3, further comprising:
periodically transferring the designated video clips from the digital video recorder units to one or more central preliminary video processing entities, for processing thereby;
at a central storage unit, periodically polling the one or more preliminary video processing entities for determining if processed designated video clips are ready for transfer to the central storage unit; and
transferring data relating to the processed designated video clips to a master database, said master database being accessed for compiling the processed designated video clips into a video product for a customer associated with the processed designated video clips.

5. The method of claim 2, wherein:
the geographic area includes at least one locale having associated therewith (i) an event that periodically occurs during the designated hours of operation and (ii) one of said cameras for capturing video content of the periodically occurring event; and
the method further comprises associating with each instance of the event an event cycle number that uniquely identifies the event instance, and associating one or more customer identifiers with the event cycle number, said customer identifiers being determined from RFID devices carried by customers at the locale of the event;
wherein the designated video clips, from among the raw video clips of the recorded video output of the camera at the locale, are associated with customer identifiers based at least in part on the event cycle numbers of the periodically occurring event.

6. The method of claim 5, wherein:
the designated video clips are identified from among the plurality of raw video clips based on time stamp data of the raw video clips in comparison to time stamp data associated with instances of the periodically occurring event.

7. The method of claim 6, further comprising generating the time stamp data associated with instances of the periodically occurring event based on sensor data received from one or more sensors associated with the event.

8. The method of claim 1, wherein:
the geographic area includes a plurality of locales, each locale having associated therewith (i) an event that periodically occurs during the designated hours of operation and (ii) one of said cameras for capturing video content of the periodically occurring event; and
the method further comprises, for each of the periodically occurring events, associating with each instance of the event an event cycle number that uniquely identifies the event instance, and associating one or more customer identifiers with the event cycle number, said customer identifiers being determined from RFID devices carried by customers in the locale of the event;
wherein for each recorded video output of a camera at a locale, the at least one clip portion of the recorded video output is associated with one or more of the customer identifiers based at least in part on the event cycle numbers of the event at the locale.

9. The method of claim 1, further comprising:
generating a video product template, said template including said stock video clips and a plurality of template video clips, said template clips having time lengths that correspond to respective projected time lengths of the video clips associated with one of the customer identifiers; and
creating the video product by replacing the template clips in the template with the video clips associated with the customer identifier.

10. The method of claim 9, wherein:
the video product is a DVD;
the template clips are in one or more .VOB files, and the video clips associated with the customer identifier are in one or more separate .VOB files; and
the DVD is in part created by replacing the .VOB files of the template clips with the .VOB files of the video clips associated with the customer identifier.

11. The method of claim 1, further comprising, for each of the RFID devices carried by customers in the geographic area:
generating a first code that is encoded in the RFID device and readable only through the RFID device; and
generating a second, different code that is printed on the outer surface of the RFID device;
wherein the first and second codes are each associated with and uniquely identify a customer associated with the RFID device.

12. A system for capturing and managing personalized video images, said system comprising:
a plurality of cameras respectively positioned at different locales in a geographic area, each of said cameras outputting video content during a designated range of hours of operation;
at least one digital video recorder interfaced with the plurality of cameras for substantially continuously recording the video outputs of the cameras;
an RFID system, said system having a plurality of RFID readers positioned at the locales for detecting customer identifiers stored on RFID devices carried by customers in the geographic area;
a video content collection system interfaced with the RFID system and the at least one digital video recorder, said system associating designated clip portions of the recorded video outputs with the customer identifiers; and
a video product creation system interfaced with the video content collection system for producing video products, wherein for each of the video products, the video product comprises a plurality of designated clips associated with the identifier of one of said customers, interspersed with a plurality of stock video clips associated with the geographic area.

13. The system of claim 12, wherein:
the geographic area is a theme park;
the locales in the geographic area are rides or other attractions at the theme park; and
for each camera, the designated range of hours of operation are the hours of operation of the ride or other attraction at which the camera is located.

14. The system of claim 12, wherein the at least one digital video recorder comprises a plurality of digital video recorders, each of said digital video recorders being positioned proximate to and uniquely associated with one of the cameras for recording the video output of the camera.

15. The system of claim 14, wherein:
each of the plurality of digital video recorders records the video output of the camera with which it is associated as a plurality of near contiguous raw video clips, said raw video clips including a first set of non-content video clips lacking video content of customers and a second set of designated video clips containing video content of customers; and
the video content collection system identifies the designated video clips from among the plurality of raw video clips for associating with customer identifiers.

16. The system of claim 15, further comprising:
one or more central preliminary video processing entities interfaced with the plurality of digital video recorders, said central preliminary video processing entities periodically receiving the designated video clips from the plurality of digital video recorders for processing thereof;
a central storage unit that periodically polls the one or more preliminary video processing entities for determining if processed designated video clips are ready for transfer to the central storage unit; and
a master database interfaced with the central storage unit, said central storage unit transferring data relating to the processed designated video clips to the master database, wherein the video product creation system accesses the master database for compiling the processed designated video clips into a video product for a customer associated with the processed designated video clips.

17. The system of claim 16, wherein the cameras, digital video recorders, central preliminary video processing entities, central storage unit, and master database are interconnected by an IP local area network.

18. The system of claim 15, wherein at each locale in the geographic area:
the locale has associated therewith an event that periodically occurs during the designated hours of operation; and
the video content collection system associates an event cycle number with each instance of the event, said event cycle number uniquely identifying the event instance, and said video content collection system additionally associating one or more customer identifiers with the event cycle number, wherein the designated video clips, from among the raw video clips of the recorded video output of the camera at the locale, are associated with customer identifiers based at least in part on the event cycle numbers of the periodically occurring event.

19. The system of claim 12, wherein at each locale in the geographic area:
the locale has associated therewith an event that periodically occurs during the designated hours of operation;
the video content collection system associates an event cycle number with each instance of the event, said event cycle number uniquely identifying the event instance, and said video content collection system additionally associating one or more customer identifiers with the event cycle number; and
the video content collection system associates the designated video clips with the customer identifiers based at least in part on the event cycle numbers of the event at the locale.

20. The system of claim 12, wherein:
the video product creation system includes a video product template, said template including said stock video clips and a plurality of template video clips, said template clips having time lengths that correspond to respective projected time lengths of the video clips associated with the customer identifiers,
wherein the video product creation system creates a video product for a designated customer by replacing the template clips in the template with the video clips associated with the customer identifier of the customer.

21. The system of claim 19, wherein:
the video product is a DVD;
the template clips are in one or more .VOB files, and the video clips associated with the customer identifier are in one or more separate .VOB files; and
the DVD is in part created by replacing the .VOB files of the template clips with the .VOB files of the video clips associated with the customer identifier.

22. A method of creating a personalized video product, said method comprising the steps of:
at a periodically occurring theme park ride, recording a video output of a camera located at the ride;
for each periodic occurrence of the ride: assigning a ride cycle number to the occurrence, said ride cycle number uniquely identifying the ride occurrence from among all other ride occurrences in the theme park; associating one or more customer identifiers with the ride cycle number, said customer identifiers being detected from RFID devices carried by customers on the ride occurrence; and associating at least one clip portion of the recorded video output with the ride cycle number, said at least one clip portion containing video content of the customers; and
for each of the customer identifiers, identifying the at least one clip portion for inclusion in a video product based at least in part on a correlation between the identifier and the ride cycle number.

23. The method of claim 22, wherein the video output of the camera is substantially continuously recorded during a designated range of hours of operation of the ride, said recorded output being digitally stored as a plurality of near contiguous video clips.
